(19) United States
(12) Patent Application Publication
(10) Pub. No.: US 2026/0121727 A1
(43) Pub. Date: Apr. 30, 2026

(54) BEAM MANAGEMENT WITH DOWNLINK Tx PREDICTION BASED ON SINGLE SIDE ARTIFICIAL INTELLIGENCE/MACHINE LEARNING MODEL

(71) Applicant: Samsung Electronics Co., Ltd., Suwon-si (KR)

(72) Inventors: Yuan-sheng Cheng, San Diego, CA (US); Mohamed Awadin, San Diego, CA (US); Hamid Saber, San Diego, CA (US); Liang Hu, San Diego, CA (US); Jung Hyun Bae, San Diego, CA (US)

(21) Appl. No.: 19/003,916

(22) Filed: Dec. 27, 2024

Related U.S. Application Data
(60) Provisional application No. 63/615,682, filed on Dec. 28, 2023.
(60) Provisional application No. 63/575,514, filed on Apr. 5, 2024.
(60) Provisional application No. 63/640,796, filed on Apr. 30, 2024.

(51) Int. Cl. H04B 7/06; H04W 24/10

(52) U.S. Cl. CPC H04B 7/06952; H04W 24/10

(57) ABSTRACT

A system, device, and a method are disclosed for AI-based beam management, including beam prediction, which may automatically optimize and control various beam management functions in wireless communication systems. The method includes obtaining, by a processor, measurements for a first set of beams, generating, by an Artificial Intelligence (AI) model, a beam prediction on a second set of beams based on the measurements of the first set of beams, selecting, by a processor, a beam from the second set of beams based on the beam prediction; and establishing, by a processor, the communication link using the beam selected from the second set of beams.

### CROSS-REFERENCE TO RELATED APPLICATION

This application claims the priority benefit under 35 U.S.C. § 119 (e) of U.S. Provisional Application Nos. 63/615,682, dated Dec. 28, 2023, 63/575,514, filed on Apr. 5, 2024, and 63/640,796, dated Apr. 30, 2024, the disclosures of which are incorporated by reference in their entirety as if fully set forth herein.

### FIELD

The disclosure generally relates to wireless communication systems. More particularly, the subject matter disclosed herein relates to improvements to beam management.

### SUMMARY

Beam management may be utilized in wireless communication technologies, such as 5G NR (New Radio) technology to support techniques used to control the directional transmission of radio signals between the base station (gNB) and user devices (UE) using advanced beamforming technologies. However, there may be issues associated with applying Artificial Intelligence (AI) techniques to beam management, in accordance with some wireless communication technology standards, in a manner that maintains the robustness and/or efficiency of AI.

To overcome these issues, systems and methods are described herein that implement AI-based beam management, including beam prediction, which modifies the application of AI to automatically optimize and control various beam management functions in wireless communication systems. Thus, the disclosed embodiments may improve the efficiency, range, and overall performance of a wireless communication network through achieving an optimized integration of AI.

In an embodiment, a method may include obtaining, by a processor, measurements for a first set of beams. The first set of beams may be received to establish a communication link. The method may further include generating, by an AI model, a beam prediction on second set of beams based on the measurements of the first set of beams, and selecting, by a processor, a beam from the second set of beams based on the beam prediction. The method may also include establishing, by a processor, the communication link using the beam selected from the second set of beams.

In an embodiment, a device may include one or more processors that are configured to perform generating a beam prediction for each beam in a second set of beams based on the measurements of the first set of beams and an AI model. The device may also be configured to perform selecting a beam from the second set of beams based on the beam prediction, and establishing the communication link using the beam selected from the second set of beams.

In an embodiment, a system may include a processing circuit and a memory device. The memory device may store instructions, based on being executed by the processing circuit, that may cause the processing circuit to perform functions. The processing circuit may obtain measurements for a first set of beams, the first set of beams may be received to establish a communication link and generate a beam prediction for each beam in a second set of beams based on the measurements of the first set of beams and an artificial intelligence (AI) model. The processing circuit may select a beam from the second set of beams based on the beam prediction and establish the communication link using the beam selected from the second set of beams.

### BRIEF DESCRIPTION OF THE DRAWINGS

In the following section, the aspects of the subject matter disclosed herein will be described with reference to exemplary embodiments illustrated in the figures, in which:

FIG. 1 depicts an example wireless network system configured to implement Artificial Intelligence (AI)-based beam management including beam prediction, according to some embodiments.

FIG. 2 is a block diagram depicting an example user equipment (UE) for AI-based beam management implementing a beam management circuit that includes beam prediction circuitry, according to some embodiments of the present disclosure.

FIG. 3 depicts an example multi-beam operation, according to embodiments of the present disclosure.

FIG. 4 depicts an example of a one-to-one mapping between a set A of beams and a set B of beams that may be implemented by beam set configuration circuitry 157, according to some embodiments of the present disclosure.

FIG. 5 depicts an example of a one-to-many mapping between a set A of beams and multiple patterns of a set B of beams that may be implemented by the beam set configuration circuitry, according to some embodiments of the present disclosure.

FIG. 6 depicts another example of a one-to-many mapping between a set A of beams and multiple patterns of a set B of beams that may be implemented by the beam set configuration circuitry, according to some embodiments of the present disclosure.

FIGS. 7A-7C depict examples of a beam indication operation that may be executed by beam indication circuitry, according to some embodiments of the present disclosure.

FIG. 8 depicts an example of a direct beam association that may be implemented as a beam indication approach by the beam indication circuitry, according to some embodiments of the present disclosure.

FIG. 9 depicts a timing operation based on time instants of reference signals that may be implemented by time instants prediction circuitry, according to some embodiments of the present disclosure.

FIG. 10 depicts a timing operation based on time instants of reporting that may be implemented by the time instants prediction circuitry, according to some embodiments of the present disclosure.

FIG. 11 is a block diagram of an electronic device in a network environment, according to some embodiments of the present disclosure.

FIG. 12 shows a system including a UE and a gNB, in communication with each other. The

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Beam management may be a critical component in wireless communication technologies, such as 5G NR, that leverages beamforming and adaptive techniques to optimize communication. Beam management may ensure efficient use of spectrum, high data rates, and robust connectivity, particularly in high-frequency bands, where signals may be susceptible to blockage and/or attenuation. With dynamic beam switching, scanning, and adaptation, beam management may enhance network performance, especially in mobile and high-demand environments.

In the realm of wireless communication technologies, advantages may be realized by leveraging Artificial Intelligence (AI) and/or Machine Learning (ML) techniques to be applied to beam management functions. AI-based beam management may be a transformative approach in such wireless communication technologies (e.g., 5G NR), and may enable adaptable and/or more efficient use of the wireless spectrum. For example, AI-based beam management may provide several advantages in wireless communication, such as ensuring that users experience higher performance, faster speeds, and/or more reliable connectivity. As AI continues to evolve, its role in beam management may become even more ubiquitous in supporting the next-generation networks with advanced capabilities and higher demands.

However, the robustness of AI-based capabilities may be limited with respect to beam management, as some beam management techniques may rely on performed measurements (e.g., L1 measurements) and reporting. In some beam management processes, each candidate beam may need to be measured before sending the measurement report and/or selecting the beam for transmission. There may be limitations related such reliance on measurements, such as increased overhead and/or latency that may be experienced in beam management process. Furthermore, this may preclude AI-based predictions from being applicable to some beams (e.g., native beams) in beam management processes, where measurements of each candidate beam may not be able to be obtained in some instances.

To improve beam management capabilities, embodiments of the present disclosure provide distinct AI-based beam management techniques, including beam prediction, that may overcome limitations to AI predictions that are associated with beam measurement and/or reporting in some standard wireless communication technologies. Embodiments of the present disclosure may support several functions to implement an enhanced AI-based beam management, the functions may include: beam prediction in a spatial-domain and a temporal domain; enhanced UE reporting capabilities; configuration of a set A of beams and a set B of beams; beam indication; and time instants prediction, as disclosed in detail herein.

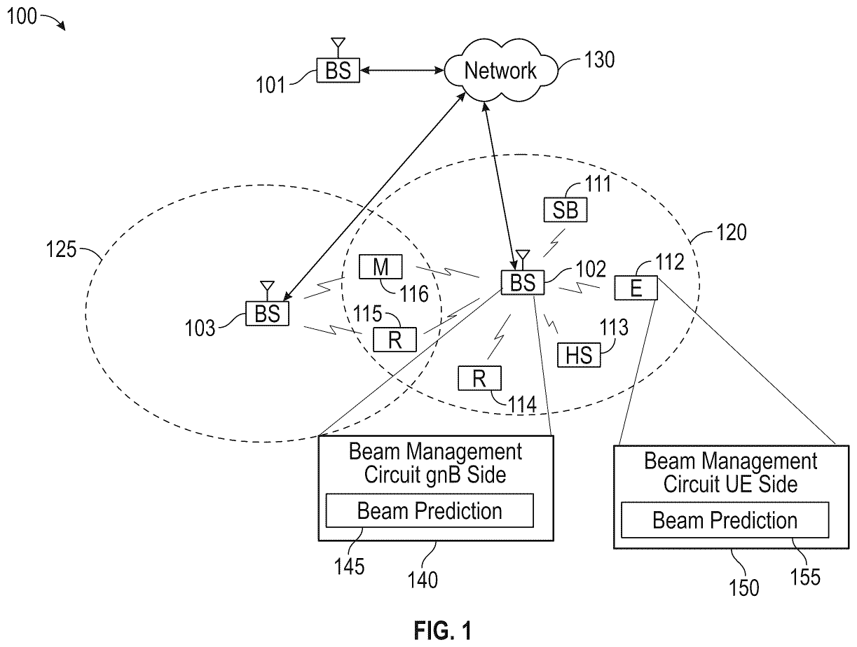

FIG. 1 depicts an example wireless network system 100 configured to implement AI-based beam management including beam prediction, according to some embodiments.

As illustrated in FIG. 1, the wireless network 100 may include multiple base stations (BS) also referred to herein as general Nodes B (gNB), shown as a gNB 101, a gNB 102, and a gNB 103. The gNB 101 may communicate with the gNB 102 and the gNB 103. The gNB 101 may also communicate with at least one Internet Protocol (IP) network 130, such as the Internet, a proprietary IP network, or other data network. Instead of gNB, a component may also be referred to herein as an enhanced Node B (eNB). Depending on the network type, other terms can be used instead of gNB or BS, such as “access point” and/or the like. As used herein, “gNB” may refer to a network infrastructure component that provide wireless access to remote terminals. Also, the wireless network 100 may include multiple wireless communication devices that may be associated with an end user, shown as user equipment (UE) 111-116. As used herein, “UE” may refer to remote wireless equipment that wirelessly accesses a gNB. The UEs 111-116 may be implemented as a mobile device (e.g., mobile telephone, smartphone, cellular device, cell phone, etc.) and/or a stationary device (e.g., desktop computer, etc.). Depending on the network type, other terms can be used instead of UE, such as “mobile station,” “subscriber station,” “remote terminal,” “wireless terminal,” or “user device.”

The gNB 102 may provide wireless broadband access to a network 130 for multiple UEs within a coverage area 120 of the gNB 102. In the example of FIG. 1, the UEs in coverage area 120 may be situated in disparate remote locations, and may include a UE 111, which can be located in a small business; a UE 112, which can be located in an enterprise (E); a UE 113, which can be located in a WiFi hotspot (HS); a UE 114, which can be located in a first residence (R); a UE 115, which can be located in a second residence (R); and a UE 116, which can be a mobile device (M) like a cell phone, a wireless laptop, a wireless PDA, and/or the like. The gNB 103 may provide wireless broadband access to the network 130 for multiple UEs within a coverage area 125 of the gNB 103. The UEs in coverage area 125 may be situated in disparate remote locations and may include the UE 115 and the UE 116. In some embodiments, one or more of the gNBs 101-103 can communicate with each other and with the UEs 111-116 using wireless technologies in accordance with known standards, including but not limited to: 5G NR; long term evolution (LTE) LTE; long term evolution-advanced (LTE-A); WiMAX; and/or other advanced wireless communication techniques.

Dotted lines in FIG. 1 may represent an approximate extent of the coverage areas 120 and 125, which are shown as approximately circular for the purposes of illustration and explanation. For example, the coverage areas associated with gNBs 101, 102, 103, such as the coverage areas 120 and 125, can have other shapes, including irregular shapes, depending upon the configuration of the gNBs 101, 102, 103 and variations in the radio environment associated with natural and man-made obstructions. The gNBs 101, 102, 103 may provide wireless access in accordance with one or more wireless communication protocols including but not limited to: 5G; 5G NR; 3GPP NR; LTE; LTE-A; high speed packet access (HSPA), Wi-Fi 802.11a/b/g/n/ac; and/or other advanced wireless communication techniques.

The gNBs 101-103 may implement a transmit (TX) path that is analogous to transmitting in the downlink (DL) to UEs 111-116 and may implement a receive (RX) path that is analogous to receiving in the uplink from UEs 111-116. In an operational example, the gNB 102 may be configured to perform DL transmissions to UEs 111-116 in the coverage area 120. For instance, DL transmission from the gNB 102 may involve transmitting data and/or control signals to be received by the UEs 111-116 over a wireless channel, in accordance with one or more wireless communication protocols. DL communication may be utilized for delivering data and/or control signals from the network (e.g., gNB) to the UEs to support several services and/or applications (e.g., browsing Internet content, software updates, streaming services, etc.).

The UEs 111-116 may implement the TX path for transmitting in the uplink (UL) to the gNBs 101-103 and may implement the RX path for receiving in the DL from the gNBs 101-103. In another operational example, one or more of the UEs 111-116 in the coverage area 120 may be configured to perform UL transmissions to the gNB 102. As an example, an UL transmission from the UE 112 may involve transmitting data and/or control signals to be received by the gNB 102 over a wireless channel in accordance with one or more wireless communication protocols. The UL communication may be utilized for transmitting user-generated data (e.g., uploads, voice, sensor data, etc.), for example, and maintaining the connections with the gNBs 101-103 through signaling and feedback.

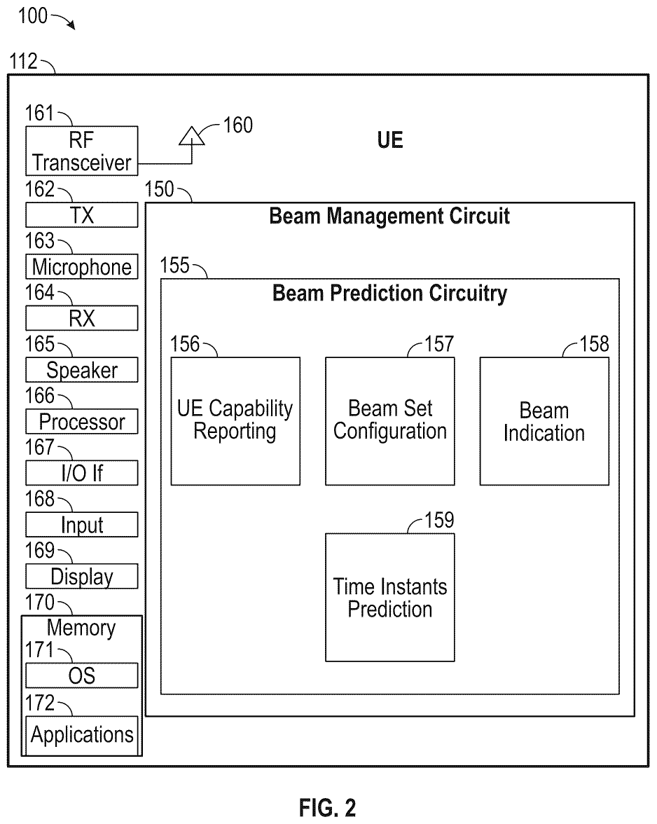

In some embodiments, one or more of the UEs 111-116 may include circuitry, programing, or a combination thereof for implementing the capabilities and/or functions related to beam management including beam prediction, as disclosed herein. In some embodiments, one or more of the gNBs 101-103 may include circuitry, programing, or a combination for implementing the capabilities and/or functions related to beam management, including beam prediction. For example, FIG. 1 depicts that gNB 102 may be configured with a beam management circuit 140 including beam prediction circuitry 145, which enables the gNb 102 to execute the capabilities and/or functions for network side beam management including beam prediction, as disclosed in greater detail herein; and UE 112 may implement a beam management circuit 150 including beam prediction circuitry 155 which enables the UE 112 to execute the capabilities and/or functions for UE side beam management including beam prediction, as disclosed in greater detail herein. The beam management circuits 140, 150 may be configured to implement improved beam management capabilities that include leveraging deep learning techniques, such as artificial intelligence (AI) and machine learning (ML), in such functions. In some embodiments, the beam prediction circuitry 145, 155 is configured to perform beam prediction in both the spatial domain and the temporal domain. Additionally, the beam prediction circuitry 145, 155 may be configured to perform AI-based beam prediction for UL and/or DL transmissions in the wireless network 100. In some embodiments, the beam prediction circuitry 145, 155 is configured to perform AI-based beam prediction with obtaining data from a reduced subset of candidate beams, thus mitigating the overhead and/or latency associated with obtaining measurements for every candidate beam. An example configuration and related functions of the beam management circuit 150 and the beam prediction circuitry 155 are described in greater detail in reference to FIG. 2, for example.

As used herein, “beam management” may refer to procedures (e.g., L1/L2 procedures) for acquiring, selecting, adjusting, maintaining, and optimizing TX and/or RX beams to maximize communication performance for UL and/or DL transmissions in high-frequency bands. In some embodiments, the beam management circuits 140, 150 may be configured to implement multiple functions related to a set of beams for wireless communication, including but not limited to: beam sweeping; beam determination; beam measurement; beam reporting; beam selection; beam prediction; beam refinement; beam switching; and/or the like, which are improved by utilizing AI techniques. As used herein, “beam prediction” may refer to procedures used in relation to beam management to predict and/or anticipate the optimal beam(s) for communication between network infrastructure component, such as gNBs and the UEs. In some embodiments, the beam prediction circuitry 145, 155 may be configured to implement multiple functions related to dynamic beam prediction, including but not limited to: spatial-domain beam (e.g., DL-TX beam) prediction; temporal-domain beam (e.g., DL-TX beam) prediction; network side (e.g., gNB) beam prediction; UE side beam prediction; top-1/N beam(s) prediction; L1-reference signal received power (RSRP) prediction; UE capability reporting; beam sets (e.g., set A and/or set B of AI model) configuration; beam indication; time instance prediction; and/or the like, which are improved by utilizing AI techniques.

In some embodiments, the beam management circuits 140, 150 and the beam prediction circuitry 145, 155 may be configured to implement AI/ML related processes and/or functions. For example, the beam prediction circuitry 145, 155 may be configured to generate, train, and/or utilize AI models to leverage past data and/or real-time measurements (e.g., beam measurements) related to the wireless communication between network infrastructure components, such as the gNBs and UEs, to predict which beam(s) will provide a signal with optimal quality and/or performance in an upcoming DL and/or UL transmission. In some embodiments, the beam prediction circuitry 145, 155 may be configured to implement beam prediction with respect to transmission beams to ultimately enable selection of the most suitable beam for a DL transmission. Thus, the enhanced beam management functions described, including beam prediction, may be utilized in the wireless network system 100 to realize several advantages associated with optimized beamforming, such as maintaining efficient and/or reliable communication, achieving high quality signals, and minimizing latency.

In operational example involving acquiring beam(s) for a DL-TX transmission, the gNB 102 may transmit reference signals through multiple beams in multiple directions to the UE 112, for example. In some embodiments, gNB 102 may initial such as Synchronization Signal Blocks (SSBs) or Channel State Information-Reference Signals (CSI-RS) through multiple beams in multiple directions. The UE 112 may receive the reference signals, and in response, report measurements and feedback associated with the reference signals back to the gNB 102. For example, the UE 112 may report information of beamformed signals based on beam measurements. Thereafter, the gNB 102 may utilize the beam prediction circuitry 145 and leverage the beam measurements received from the UE 112 to predict a signal (e.g., beam) that is a deemed optimal for the DL communication. The beam prediction circuitry 145 may implement an AI model that receives the beam measurements as input, where the AI model is trained to infer the potential performance of the beams in a DL transmission with the UE 112. The beam prediction circuitry 145 may determine which one of the beams has the highest likelihood to have an optimal quality and/or performance for the DL transmission with the UE 112. Performance of a beam may be ascertained based on multiple signal metrics including but not limited to: reference RSRP; signal-to-interference-plus-noise ratio (SINR); reference signal received quality (RSRQ); and/or the like. The beam management circuit 140 of the gNB 102 may select the top beam (e.g., highest performance) predicted by the beam prediction circuitry 145 to be utilized for an upcoming DL transmission to the UE 112. In some embodiments, beam management predictions output by the beam prediction circuitry 145 may be applied to enhance and/or automatically optimize functions performed by the beam management circuit 150, including but not limited to: initial beam selection; TX and/or RX beam selection; beam switching; beam handover; and/or the like.

As described herein, components in a wireless network, such as the gNB 102 and the UE 112, may be enabled to perform enhanced beam management functions to support high quality UL and/or DL transmissions, including beam prediction. By implementing beam prediction, wireless technologies, such as 5G NR, may leverage AI-based capabilities to proactively predict and select beams for UL and/or DL transmissions, ensuring robust communication in a manner that reduces disruptions (e.g., beam switch or handover), reduces overhead (e.g., minimizes beam sweeping), and improves efficiency (e.g., maximizes signal strength, optimizes beam alignment, etc.).

FIG. 2 is a block diagram depicting an example UE 112 for AI-based beam management implementing a beam management circuit 150 that includes beam prediction circuitry 155, according to some embodiments of the present disclosure.

As illustrated in FIG. 2, an example configuration of the UE 112 (e.g., shown in FIG. 1) can include multiple hardware and/or software components implementing the aforementioned capabilities related to AI-based beam management including beam prediction. The UE 112 depicted in FIG. 2 is not intended to be limiting, and the related structure and/or functions of the component may be implemented a wide variety of configurations, without departing from the scope of this disclosure. In some embodiments, the UE 112 may be configured to implement the functions related to AI-based beam management including beam prediction that are performed on the UE side, as disclosed herein.

Additionally, in some embodiments, a gNB (e.g., gNB 102 shown in FIG. 1) may be configured with similar hardware and/or software components to implement the capabilities related to AI-based beam management including beam prediction as described in reference to FIG. 2. In some embodiments, the gNB may be configured to implement the functions related to AI-based beam management including beam prediction that are performed on the network side, as disclosed herein.

As shown in FIG. 2, the UE 112 may be configured to include an antenna 160, a radio frequency (RF) transceiver 161, TX processing circuitry 162, a microphone 163, and RX processing circuitry 164. The UE 112 may also include a speaker 165, a processor 166, an input/output (I/O) interface (IF) 167, an input device 168, a display 169, and a memory 170. The memory 170 may include an operating system (OS) 171 and one or more applications 172.

The RF transceiver 161 may receive from the antenna 160, an incoming RF signal transmitted by a gNB (e.g., gNB 102 in FIG. 1) of the network 100. The RF transceiver 161 may down-convert the incoming RF signal to generate an intermediate frequency (IF) or baseband signal. The IF or baseband signal can be sent to the RX processing circuitry 164, which may generate a processed baseband signal by filtering, decoding, and/or digitizing the baseband or IF signal. The RX processing circuitry 164 may transmit the processed baseband signal to the speaker 165 (such as for voice data) or to the processor 166 for further processing (such as for web browsing data).

The TX processing circuitry 162 may receive analog or digital voice data from the microphone 163 or other outgoing baseband data (such as web data, e-mail, or interactive video game data) from the processor 166. The TX processing circuitry 162 may encode, multiplexes, and/or digitizes the outgoing baseband data to generate a processed baseband or IF signal. The RF transceiver 161 may receive the outgoing processed baseband or IF signal from the TX processing circuitry 162 and can up-convert the baseband or IF signal to an RF signal that is transmitted via the antenna 160.

The processor 166 may include one or more processors or other processing devices and execute the OS 171 stored in the memory 170 in order to control the overall operation of the UE 112. For example, the processor 166 may control the reception of forward channel signals and the transmission of reverse channel signals by the RF transceiver 161, the RX processing circuitry 164, and the TX processing circuitry 162. In some embodiments, the processor 166 may include at least one microprocessor or microcontroller.

The processor 166 may also be capable of executing other processes and programs resident in the memory 170 and the beam management circuit 150, such as processes for AI-based beam management. The processor 166 may move data into or out of the memory 170 as required by an executing process. In some embodiments, the processor 166 may be configured to execute the applications 172 based on the OS 171 or in response to signals received from gNBs or an operator. The processor 166 may also be coupled to the I/O interface 167, which provides the UE 112 with the ability to connect to other devices, such as laptop computers and handheld computers. The I/O interface 167 may provide the communication path between these accessories and the processor 166.

The processor 166 may also be coupled to the input device 168 and the display 169. The operator of the UE 112 may use the input device 168 to enter data into the UE 112. The input device 168 may be a keyboard, touchscreen, mouse, track ball, voice input, or other device capable of acting as a user interface to allow a user in interact with the UE 112. For example, the input device 168 may include voice recognition processing, thereby allowing a user to input a voice command. In another example, the input device 168 may include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme.

The processor 166 may also be coupled to the display 169. The display 169 may be a liquid crystal display, light emitting diode display, or other display capable of rendering text and/or at least limited graphics, such as from web sites.

The memory 170 may be coupled to the processor 166. Part of the memory 170 may include a random-access memory (RAM), and another part of the memory 360 could include a Flash memory or other read-only memory (ROM). In some embodiments, the memory 170 may store data (e.g., beam sets, beam measurements, etc.) and/or models (e.g., AI models) associated with AI-based beam management including beam prediction functions, as disclosed herein. In some embodiments, the memory 170 may store models generated, trained, and/or utilized by the beam management circuit 150 and the beam prediction circuitry 155.

The beam prediction circuitry 155 may include components implementing various aspects of the AI-based beam prediction capabilities of the UE 112, as disclosed herein. As illustrated in FIG. 2, the beam prediction circuitry 155 may also be configured with circuitry, including but not limited to: UE capability reporting circuitry 156; beam set configuration circuitry 157; beam indication circuitry 158; and time instants prediction circuitry 159.

In some embodiments, the beam prediction circuitry 155 may be configured to implement a spatial-domain beam prediction, as disclosed herein. For example, spatial-domain beam prediction may involve predicting a set A of beams based on the measurement of a set B of beams. In some embodiments, the training and inference of an AI model utilized for AI-based spatial-domain beam prediction, as disclosed herein, may be performed on the network side (e.g., at gNB 102). In some embodiments, the training and inference of an AI model utilized for AI-based spatial-domain beam prediction, as disclosed herein, may be performed on the UE side (e.g., at UE 112).

In some embodiments, the beam prediction circuitry 155 may be configured to implement a temporal-domain beam prediction, as disclosed herein. For example, temporal-domain beam prediction may involve predicting a set A of beams based on the based on the historic measurement results of the set B of beams. In some embodiments, the training and inference of an AI model utilized for AI-based temporal-domain beam prediction, as disclosed herein, may be performed on the network side (e.g., at gNB 102). In some embodiments, the training and inference of an AI model utilized for AI-based temporal-domain beam prediction, as disclosed herein, may be performed on the UE side (e.g., at UE 112).

The beam prediction circuitry 155 may be configured to generate, train, and/or utilize AI models to support the functions related to AI-based beam prediction, as disclosed herein. Measurements based on a set B of beams may be used as input into the AI model. In addition, beam ID information may be also provided as input to the AI model. In some embodiments, the AI models may be trained to output a probability of each beam in set A to be a top-1 beam, and to predict some properties (e.g., L1-RSRPs) that may correspond to the beams in the set A. As used herein, “set A” may refer to a set of beams predicted by the inference capabilities of the AI model. As used herein, “set B” may refer to a set of beams whose measurements are utilized as inputs into the AI model. Set B may be a subset of set A in some instances. In other instances, set B may include a different set of beams than set A. For example, set B may include wider beams associated with different SSB's, and set A may include finer beams associated with different CSI-RS (e.g., based on the hierarchy).

Based on the model output, the beam prediction circuitry 155 may ultimate predict the top-1/N (N is a number of selected beams) beams among the set A of beams with the corresponding predicted beam properties. In some embodiments, the UE 112 may report the prediction result to the network (e.g., gNB 102) based on the output of AI model (e.g., UE side) and/or the beam prediction circuitry 155. In some embodiments, the beam prediction circuitry 155 may implement some aspects of the beam prediction functions, but the network (e.g., gNB 102) may execute the prediction of the Top-1/N beams (e.g., based on the reported measurements of a set B of beams).

The UE capability reporting circuitry 156 may be configured to implement UE capability reporting to inform the network (e.g., gNB) about capabilities related to AI-based beam management, including beam prediction, in a manner that may ensure efficient resource allocation, feature support, and service optimization. In some embodiments, the UE capability reporting circuitry 156 may be configured to report capability of the UE 112 utilizing set size pairs (X,Y) (e.g., in terms of a size of set A, and a size of set B) for implementing spatial-domain beam prediction (e.g., UE side). Regarding UE side beam management (e.g., UE side model), a model may be trained with a defined set A of beams and a defined set B of beams. However, information conveying the configuration details (e.g., beam codebooks) for the set A of beams and the set B of beams may be considered private (e.g., containing gNB privacy information), therefore the beam configuration information for the set A of beams and the set B of beams may not be available (e.g., disclosed to the public, vendors, etc.). In some cases, some configuration details (e.g., beam codebooks) may be realized implicitly by the model during training (e.g., offline training). Alternatively, reference codebook(s) and reference channel model(s) may be defined for the UE to train the models. Regardless which approaches is used, the size of the set A of beams and the size of the set B of beams may be related to the complexity and/or structure of the model. Therefore, it may be advantageous for the UE capability reporting circuitry 156 to be configured to define the UE capability utilized in beam prediction (e.g., spatial-domain beam prediction, and UE side) to be based on the size of set A of beams and the size of set B of beams. As used herein, the “size” of a set of beams may refer to the number of beams included in the set.

The size of the set A of beams may be related to the output size of the model, thus a different size of the set A of beams may result in a different model. The size of the set B of beam may be related to input size of the model. Further, a relationship (e.g., ratio) between the size of the set A of beams and the size of the set B of beams may affect the prediction performance of the models. Also, in some cases, the gNB may need a different size of a beam codebook in order to adopt different scenarios and antenna configurations. Therefore, UE capability may be defined in term of size pairs for the sets, for instance a “(X [size of set A], Y [size of set B])” pair.

For example, the UE capability reporting circuitry 156 may be configured to report multiple size pairs for the sets, such as (64, 32) (64, 16), (64, 8), (32,16) and (32,8) to indicate that the UE 122 supports various set size pair (X,Y) combinations. With respect to performance, it may be important for the models to maintain consistency during the training and inference stages for the association of set A and set B. Thus, one or more ratios for set size pairs (X, Y) may be defined and/or utilized by the UE capability reporting circuitry 156, where defined ratios may include ¼, ⅛, and/or the like as deemed necessary and/or appropriate. In some embodiments, the UE capability reporting circuitry 156 may enable various candidate set size pairs (X,Y) (e.g., set A, set B pairs) to be available by implementing the defined ratios.

In some cases, there may be many variations of beam codebooks, for instance a beam codebook may be vendor specific and/or site specific. As a result, a gNB site may have multiple TX beam codebooks for a particular size of set of beams (e.g., set A of beams). Thus, in some embodiments, the UE 112 (and/or a gNB) may be configured to train the models (e.g., offline training) according to specified conditions related to the UE capability reporting (e.g., additional codebooks). As an example, with respect to spatial-domain beam prediction, the gNB may be configured based on the capabilities reported by the UE 112 utilizing (X, Y) pairs (e.g., size of set A of beams, and size of set B of beams).

For instance, if the UE capability reporting circuitry 156 reports the pair (64,32) as the UE capability (e.g., for spatial-domain domain prediction) for UE 112, a gNB can configure a beam codebook with size 64 to be used for training of the model (e.g., offline training associated with a particular vendor and/or UE). Training may be further differentiated by additional conditions that may be associated with the gNB side (e.g., different codebook, antenna configurations, etc.) through signaling related information (e.g., model ID) to the UE 112. Therefore, the UE 112 may receive information indicating the model to be used based on the configuration and additional signaling. In some cases, the UE 112 may have multiple models for a particular set size pair (X,Y) (e.g., size of set A, size of set B) that is differentiated by additional conditions associated with the UE side. Accordingly, the UE 112 may control and/or detect the additional conditions and switch the models utilized for beam prediction.

In some embodiments, the UE capability reporting circuitry 156 may be configured to report the capability of the UE 112 to share a model between different set Bs for a same size of set A of beams, for implementing spatial-domain beam prediction (e.g., UE side). In some embodiments, the model(s) utilized for AI-based beam prediction may be able to adopt various set sizes (e.g., the size for the set B of beams) as input. In that case, the UE 112 may be able to report that is has the additional capability to share the model between different sets Bs for a given size for the set A of beams. To maintain the consistency between set A of beams and set B of beams during training and inference of the model, the gNB may utilize multiple set Bs which are subsets of a unified set (e.g., set C), the sets can be aligned during the training of the model. In some embodiments, the UE capability reporting circuitry 156 may configure and/or signal the set Bs with indexes in a unified set (e.g., set C).

In some embodiments, the UE capability reporting circuitry 156 may be configured to further report the capability of the UE 112 to support time variable of the set B, for implementing spatial-domain beam prediction (e.g., UE side). In some embodiments, the UE capability reporting circuitry 156 may be configured to define a maximum size for a set B of beams. The set B of beams can vary during the training and/or inference phase, given that additional signaling (e.g., relative beam indexes) is provided to maintain the consistency between beam indexes. Some models can handle various set Bs over time. Thus, the UE capability reporting circuitry 156 may further report support to various set Bs over time. To maintain the beam consistency, a gNB may need to configure and/or indicate a relative beam index of the set B of beams to the UE 112 during the inference and/or training stage.

In some embodiments, the UE capability reporting circuitry 156 may be configured to report the capability of the UE 112 based on a maximum size of the set A of beams and a maximum size of set B of beams, for implementing spatial-domain beam prediction (e.g., UE side). In some embodiments, the UE 112 may be able to adopt various sizes for set As and various sizes for set Bs with the same hardware, given the models were trained and aligned (e.g., on the UE and gNB sides) based on signaling.

In some embodiments, the UE capability reporting circuitry 156 may be configured to utilize different reporting quantities (e.g. L1-RSRP, or channel impulse response (CIR)) and a maximum K of the best predicted beam, as an optional capability of the UE 112, for implementing spatial-domain beam prediction (e.g., UE side). Depending on the model, in some cases, there can be a different report quantity communicated to the gNB during the inference phase (e.g., L1-RSRP, channel impulse response (CIR), etc.). The report quantities may be based on a predicted beam ID (e.g., in set A of beams) and corresponding measurement (e.g., L1-RSRP), or a K-best predicted beam ID and corresponding measurements.

As previously described, the UE capability reporting circuitry 156 may be configured to deploy different models for different sizes of the set A of beams, and different sizes of the set B of beams. For example, the UE 112 may indicate to the gNB via capability signaling the number of models that are used to support different sizes for set A and/or set B, and if a particular model can support different sizes for set A and/or set B.

TABLE 1
Model Ids and the supported sizes of Set A/Set B

| Group index | Support sizes of Set A/Set B |
|---|---|
| 0 | Set A: 64, 128 |
| | Set B: 16, 32 |
| 1 | Set A: 16 |
| | Set B: 4 |
| . . . | . . . |

Table 1 depicts an example of a UE capability signaling that may be generated by the UE capability reporting circuitry 156 indicating two models. As shown in Table 1, Model 0 may support Group index 0 of possible sizes of set A and set B. In Table 1, the Group index 0 may support two sizes of Set A (e.g., 64 and 128) and two sizes of set B (e.g., 16 and 32). Also in Table 1, the Model 1 may support Group index 1 of possible sizes of set A and set B, including a single size of Set A (e.g., 16) and single size of set B (e.g., 4). The UE capability reporting circuitry 156 may be configured to additionally indicate to the gNB a minimum switching time utilized to switch the model (e.g., via capability signaling) if the UE 112 can run both models simultaneously. For example, if the gNB indicates to the UE 112 to provide CSI report based on using Model 0 (e.g., set size pair (64, 16)) and the gNB indicates to the UE to provide CSI report based on using Model 1 (e.g., set size pair (16,4)) then the gNB may have to ensure there is enough time between two reports. A time gap may be measured between the last symbol carrying the earlier report that used the former model to the first symbol corresponding to the earliest RS used for deriving the report based on the latter model. The time gap may also be measured between the last symbol carrying the earlier report that used the former model to the first symbol corresponding to the report derived by the latter model.

In some embodiments, if the model may be used for multiple sizes for set A and for multiple sizes for set B, a minimum time may not be utilized for switching the model (e.g., legacy processing timeline and CPU occupations may need to be satisfied). For example, the gNB may configure the UE 112 to report two CSI reports, the first CSI report may be based on the size of set A (e.g., 64) and the size of set B (e.g., 16) while the second CSI report is based on another size of set A (e.g., 128) and another size of set B (e.g., 32) with no additional time gap between the two reports (associated with model switching), as the CSI reports may use the same model.

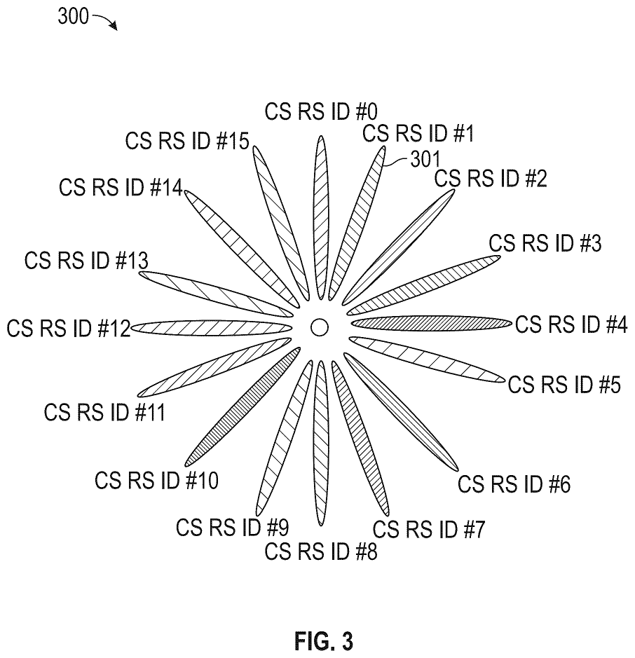

In some embodiments, the UE capability reporting circuitry 156 may be configured to report conditions of the set A of beams and the set B of beams that the UE 112 may support through indication of a specific set A of beams and a specific set B of beams that are supported, and/or by indicating other properties of set A and set B (e.g., not related to set sizes). For example, the UE 112 may report that it supports any configuration of set A and set B with a particular set A size (e.g., 4) and a particular set B size (e.g., 2). For the model to be able to predict the RSRPs of refence signals in set A from the measurements in set B, the two sets of RSRPs as random variable may be correlated. This correlation may be referred to as spatial closeness and/or correlation of the reference signals (or beams) based on the RSRPs. For instance, as illustrated in FIG. 3, a gNB may transmit 16 CSI reference signals 301 (e.g., beams) in different directions.

FIG. 3 illustrate an example multi-beam operation 300 according to embodiments of the present disclosure. An embodiment of the multi-beam operation 300 shown in FIG. 3 is for illustration only and other embodiments can be used without departing from the scope of the present disclosure. The multi-beam operation 300 of FIG. 3 may be performed by a gNB (e.g., see gNB 102 in FIG. 1), transmitting multiple signals 301 (e.g., beams).

In a wireless system, components, such as gNBs and UEs, can transmit and/or receive on multiple beams which may be referred to as a “multi-beam operation” and illustrated in FIG. 3. While FIG. 3, for illustrative purposes, is in 2D, it may be apparent to those skilled in the art, that a signal 301 (e.g., beam) may be 3D, where a beam can be transmitted to or received from any direction in space.

If set B indices is B={0,1} and set A indices is A={2,3, 14, 15}, the spatial closeness and the corresponding correlation may be sufficient for the model to predict the RSRPs of the set A from set B. However, it may be more difficult to predict the RSRPs of set A={7, 8, 9, 10} from set B. Therefore, indicating the sizes may not be sufficient for indicating UE capability to support set A and set B.

Referring back to FIG. 2, the UE capability reporting circuitry 156 may be configured to report the sets A and the set B that the UE 112 can support. It may also be possible for the UE 112 to declare a pair of “super” set A and a “super” set B (e.g., referred to as A′ and B′) such that every subset of the two sets can be paired as a supported case by the UE 112. This may be ensured during the training of the model, and may and reduce overhead associated with UE capability reporting.

In some cases, UE mobility may affect the set A and the set B that may be supported by the UE 112. For example, if the UE 112 is in a location in the cell where the RSRP of a CSI-RS #0 is the largest and is configured with set B={0,1} and set A={2,3,14,15} the sets may support beam prediction due to spatial closeness. If the UE 112 moves in the cell such that the RSRP of a CSI-RS #8 is the largest, a new configuration of set B={8,9} and set A={6,7,10, 11} may work with similar prediction performance in a previous configuration due to the same spatial layout. If the UE 112 reports the strongest received beam to the gNB (e.g., CSI-RS #8) the gNB may configure the UE 112 with the new set. The gNB may assign CSI reference signals 301 which are spatially close to each other, and/or IDs which are close to each other (e.g., see FIG. 3) then a special type of reporting may be more efficient. For instance, if the CSI reference signals 301 are assigned IDs in a determined order as they sweep all directions (e.g., see FIG. 3) and the UE 112 reports the support of set A1 and set B1, it may also support set A2, and B2 where A2 and A1 are simply the shifted versions of A1 an A2 for any shift offset index s. That is, if the UE 112 may support A1 and B1, it may also support A2 and B2, which is represented mathematically as:

$${A}_{2} = \{ mod ( i + s , N ) \vert i ∈ {A}_{1} \} \qquad ( eq . 1 )$$

$${B}_{2} = \{ mod ( j + s , N ) \vert j ∈ {B}_{1} \} \qquad ( eq . 2 )$$

where s is an integer value, N is the total number of refence signals which cover all directions

As an example, if N=16, and s=8 applying eq. 1 may yield A₂={6,7,10,11} and applying eq. 2 may yield B₂={8,9}. Continuing with the example, a particular gNB implementation for reference signal ID assignment and beam lay-out may be utilized in the space. Since ID assignment may not affect any other aspects of system performance, that gNB may be allowed to assign in this manner. The value of s is to reflect the UE mobility. gNB will know who to configure the new sets of A and B based on the reported strongest beam by the UE. The value of N may be related to the RRC configured to the UE 112 or communicated (e.g., handshake) during the training phase.

In some embodiments, the UE capability reporting circuitry 156 may be configured to report if the UE 112 supports UE side additional conditions (e.g. doppler), for implementing spatial-domain beam prediction (e.g., network side). For example, the UE capability reporting circuitry 156 may communicate one or more UE side additional conditions (e.g., doppler frequency) to the gNB during UE reporting. Based on the reported capabilities of the UE 112, the gNB may configure the corresponding CSI reports and resource sets. The UE 112 may report the number of reported RSRSPs that in the set B of beams (or may report the entire set B of beams). The full indices may be given in the CSI resource set. The UE 112 may report a beam with the strongest RSRP and/or a differential RSRP (with respect to the strongest RSSP) for the other beams. Various other UE side additional conditions (e.g., estimated doppler frequency) may also be reported (e.g., according to the CSI report configurations).

Additionally, in some embodiments, the UE capability reporting circuitry 156 may be configured to support different measurement types and a maximum number of measurement quantities that are include in a report, for implementing spatial-domain beam prediction (e.g., network side). During an inference stage (e.g., after a network side model is trained at the gNB), the AI-based operations performed by the gNB may be transparent to UE 112. As a result, the UE 112 may report the measurements (e.g. L1-RSRP) for the set B of beams to the gNB, which are then utilized by the model and AI functions at the gNB. Since the set B of beams can be configured by CSI resource and CSI-reporting, potential impacts may be limited to a new report format with number of beams and measurement quantities (e.g. L1-RSRP) larger than a certain size (e.g., 4). Thus, including a maximum number of the different types of measurement quantities in a report may be a UE capability implemented by the UE capability reporting circuitry 156. In some instance, when the UE 112 may report the maximum number of the different types of measurement quantities (e.g., 4 strongest beams), the network side model (e.g., at the gNB) may achieve performance that is deemed suitable for efficient and/or accurate beam predict.

In some embodiments, the beam set configuration circuitry 157 may be configured to determine and/or configure the set A of beams and/or the set B of beams that may be utilized for implementing spatial-domain beam prediction (e.g., UE side). In accordance with some current wireless network technology standards (e.g., NR, 5G NR, etc.) beam management may be based on CSI resources (e.g., including SSB) and CSI reports configured by the gNB. The UE 112 may perform measurements according to these configurations. For the UE 112 to support AI-based beam management, as disclosed herein, this operation of the UE 112 may be modified and enhanced by supporting the beam set configuration capabilities, as disclosed herein.

In some implementations, the UE 112 may perform measurements for the configured DL reference signal resources (for the set B of beams), and then may use these measurements as inputs for the model (e.g., UE side model). Therefore, it may not be beneficial for the gNB to receive all measurements from the UE 112 in reporting. In such cases, L1-RSRP reports in accordance with some wireless communication standards (e.g., 5G NR) may be reused. For instance, the UE 112 may report a defined number of predicted beams (e.g., 4 best predicted beams) with associated predicted measurement quantities. If the best-K beams are selected as the output of the model, a potential new report quantity and a maximum number of report entries may be implemented (e.g., by the UE capability reporting circuitry 156).

An example of a new report quantity may include uncertainty of beams, which provides additional information to the gNB on the quality of a beam report based on the beam prediction of the AI model. This could improve operations of the gNB, including performance monitoring. The uncertainty of beams may be calculated utilizing the input and/or output distribution of the AI model. It may be possible to regulate a confidential level of beams based on measurements and/or characteristics (e.g., L1-RSRP). The quantity (e.g., uncertainty of beams) may be related to the UE specific implementation of the AI model, in some cases. Thus, the UE 112 may be configured to specify a range associated with a confidence level (e.g., range for confidence level of beam is between 0-9) based on the UE capability, and report the uncertainty of beams (e.g., using the confidence level) based on the estimation (e.g., at the UE 112).

In some cases, resources associated with the set B of beams may be utilized since the measurements of the set B of beams are used as the input for UE side model. The UE 112 may use CSI resource configuration in these instances. If the gNB is configured, then additional information or a new type of configuration for the multiple set Bs may be used. In some embodiments, a standard CSI resource (e.g., NR standard CSI resource) may be employed, and additional parameters (e.g. different report quantity) may be added to differentiate the standard CSI report (e.g., NR standard CSI report) from a CSI report for AI-based beam management, as disclosed herein. In some embodiments, a resource reporting that is specific to an AI model may be utilized that may refer to a standard CSI report. Parameters that may be specific to the AI model may also be included in the resource reporting for AI-based beam management. Accordingly, the UE 112 may process and/or identify resources and reports that are related to AI-based beam management.

In some embodiments, a new report quantity (e.g., reportQuantity parameter) may be introduced in a CSI configuration report. The report quantity value may be used to configure the UE 112 to report the best K reference signal (e.g., CSI-RS ID) from the set A of beams and the corresponding RSRP, and/or the report quantity value may be used to configure the UE 112 to report the best K reference signal (CSI-RS ID) from the set A of beams without the corresponding RSRP. The value of “K” best beams may be configured by a higher layer signaling (e.g., RRC parameter). In case of the absence of such parameter, the UE 112 may report the best beam with or without the corresponding RSRP. The new report quantity may be utilized for RSRP reporting and/or applied for L1-SINR reporting.

Additionally, the gNB may provide the UE 112 with reference signals to be measured, which are used as input to the AI model (e.g., set B of beams). Therefore, a resource set (e.g., nzp-CSI-RS-ResourceSetList, csi-SSB-ResourceSetList) may be re-interrupted as reference signals of the set B to be used as input to the AI model.

In some embodiments, the gNB may indicate multiple “nominal” set Bs and the corresponding set As (e.g., rather than indicating a specific set B, and the corresponding set A, as part of the configurations of the CSI report). Configuring at least one “nominal” set B of beams may be beneficial, as it may allow the gNB to indicate which set B and set A may be used for the triggered CSI report. For example, for semi-persistent CSI reporting, the triggering Medium Access Control-Control Element (MAC-CE) and/or the Physical Downlink Control Channel (PDCCH) may indicate which Set B of beams and, possibly the corresponding set A of beams that should be used for this triggered semi-persistent CSI report. Similarly, for aperiodic CSI reporting, the triggering PDCCH may indicate which set B of beams, and possibly the corresponding set A of beams, that should be used for the triggered the aperiodic CSI report. Different pairs of set Bs and set As may be assigned an index. Using this approach, the triggering MAC-CE or PDCCH may indicate the proper index. For example, an additional field may be introduced in the MAC-CE and/or PDCCH or some existing fields may be fully and/or partially repurposed.

In some embodiments, the beam set configuration circuitry 157 may be configured to determine and/or configure the set A of beams that corresponds to the set B of beams. For example, during the training phase (e.g., online training of the model, or offline training of the model), the UE 112 may train different models for different set As, where each set A may potentially be associated with a different codebook size. The relationship between the set A of beams and the set B of beams may be determined and/or configured by the beam set configuration circuitry 157 using one or more techniques.

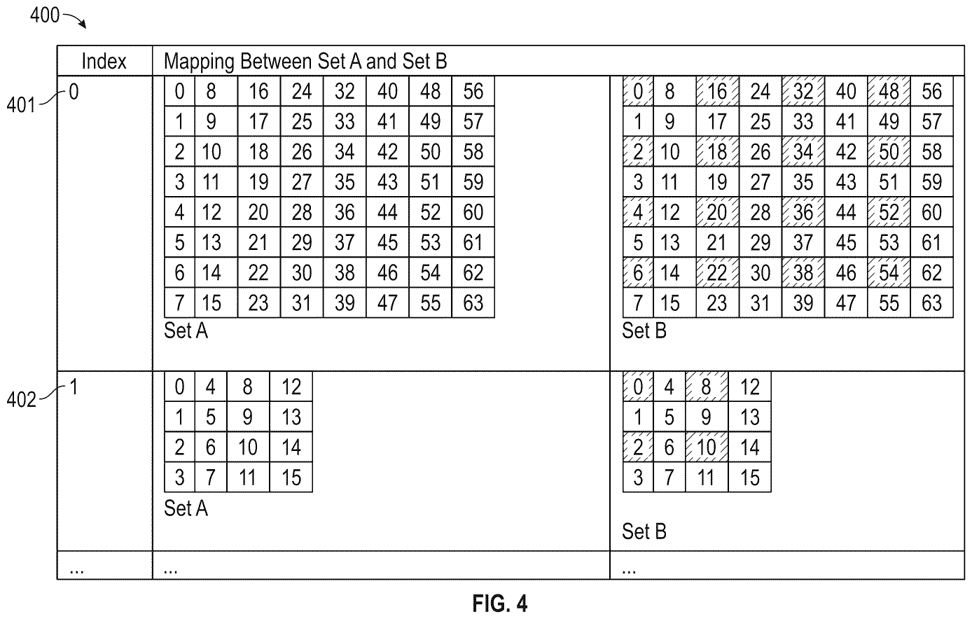

In some embodiments, the beam set configuration circuitry 157 is configured to implement a one-to-one mapping between the set A of beams and the set B of beams to determine the relationship between the sets. In this approach, each set A of beams may be associated with an individual set B of beams. In FIG. 4, an example of a one-to-one mapping 400 between the set A of beams and the set B of beams that may be implemented by the beam set configuration circuitry 157 is depicted. Each number in the -to-one mapping 400 may refer to a particular beam. The first row 401 in the -to-one mapping 400 refers to 64 beams that are possibly generated by 64-Discrete Cosine Transform (DFT) codebook (e.g., weighting coefficients are generated from 64-DFT matrix). The beam index in row 401 of the one-to-one mapping 400 may refer to a particular row or column in the 64-DFT matrix. The shaded cells in row 401 of the one-to-one mapping 400 may refer to beam to be used for the set B of beams. In row 402 of the one-to-one mapping 400 the UE refers to 16 beams that are possibly generated by 16-Discrete Cosine Transform (DFT) codebook. For example, in the one-to-one mapping 400 may configure the set A of beams (0, 2, 8, 10) to be used for inference.

In some embodiments, the gNB may provide the UE 112 with the codebook and/or indicators of the codebook (e.g., codebook size, codebook type, etc.) that is being utilized (e.g., 64-DFT or 16-DFT). In some embodiments, the gNB may provide the UE 112 with the codebook during an inference phase of the model during AI-based beam management. Alternatively, multiple indexed codebooks may be predefined and the gNB may provide the UE 112 with the index to be used.

The details of the implementation of the codebooks may not be revealed if the pair of set A of beams and the set B of beams may be associated by an index. For example, in row 401 of the one-to-one mapping 400 the pair of set A and set B is indexed as 0, the in row 402 of the one-to-one mapping 400 the pair of set A and set B is indexed as 1, and so on. In this case, the gNB may indicate the pair index. Since there may be a single pattern for set B (which may be known during the training phase) each row 401, 402 in the one-to-one mapping 400 may indicate the size of the set A of beams and the size of the set B of beams. Such indication may be carried via higher layer signaling such as RRC (e.g., RRC parameter AI_ML_SetA_SetB as part of CSI-ReportConfig). In this case, the UE 112 may expect to be configured with reference signals that are consistent with those used during the training phase.

For example, if index 1 from the one-to-one mapping 400 is indicated, the UE 112 may expect to be configured with four reference signals as equivalent to beams (0, 2, 8, 10). To this end, the gNB may configure a resource set including four reference signals (e.g., CSI-RS IDs 11, 12, 18, 20). Those reference signals may be mapped to the beams in set B in ascending order. For example, CSI-RS ID 11 may be equivalent to beam 0 in set B, CSI-RS ID 12 may be equivalent to beam 2 in set B, the CSI-RS ID 18 may be equivalent to beam 8 in set B, and CSI-RS ID 20 may be equivalent to beam 10 in set B. Although in the previous example, ascending order is used to map the reference signal IDs to the beams in the set B of beams, other rules may be applied such as descending order, ordering based on configured sequence of resource in a resource set, and/or the like. For instance, CSI-RS ID X may be equivalent to beam Y in the set B of beams, indicating for the beam used to transmit CSI-RS ID X during inference and the CSI-RS ID Y during training. This may indicate several properties related to set configuration including, but not limited to: the reference signals used to transmit both beams have the substantially similar Quasi Co-Location (QCL) properties (e.g., according to a type); both beams have the substantially similar coverage area; both beams have the substantially similar boresight direction; a substantially similar spatial filter is used for transmitting or receiving both beams.

In some cases, to ensure consistency during training and inference of the models, the order of CSI-RS ID mapping to beam ID (e.g., ascending order of RS ID and beam ID, etc.) may be consistent during training and inference. This consistency may ensure suitable performance of the model (e.g., once the correct model is identified). Consistency during training and inference of the models may also be maintained by utilizing substantially similar mapping between the CSI-RS ID and the physical beam during the inference and training stages of the model. Thus, the UE 112 may identify the beam ID through the CSI-RS ID directly during the inference. As an example, the UE 122 may determine that if a reference signal (e.g., CSI-RS or SSB) with a certain ID is transmitted (e.g., during data collection for training the model) with a specific physical beam property such as QCL (or other properties described above) a reference signal with the same ID in the inference phase may be transmitted with the same physical beam properties.

In some instances, the gNB may indicate to the UE 122 a pattern for the set B of beams (e.g., rather than assuming that the pattern of set B is known at the UE 112). For example, a bitmap may be used for this purpose. In this case, the gNB may indicate set A of beams and an additional bitmap indicating which beams are to be used to construct the set B of beams. For example, if set A has 64 beams, then a bitmap of 64 bits may be used to select a subset of those beams. This may beneficial if the gNB wants to change the pattern of set B compared with the one used during the training phase. In some embodiments, the gNB may signal indices and/or IDs of the beams to be used as set B (out of the beams of set A, in lieu of and/or in addition to using a bitmap.

In some embodiments, the beam set configuration circuitry 157 may be configured to dynamically update the mapping between the set A of beams and the set B of beams. This capability may be beneficial when the gNB adapts its codebook dynamically (e.g., in the context of network energy saving (NES)). Therefore, in some embodiments, the association between the set A of beams and the set B of beams may be provided as part of sub-configurations. For example, a CSI configuration (e.g., csi-ReportSubConfigList) may contain a RC parameter (c . . . g, AI_ML_SetA_SetB), for example, to indicate the applicable association between the set A of beams and set B of beams corresponding to this sub-configurations. Therefore, when a particular sub-configuration is configured and/or triggered, the UE 112 may determine the set A and/or set B to use.

In some embodiments, the beam set configuration circuitry 157 may be configured to determine a one-to-many mapping to indicate the relationship between the set A of beams and the set B of beams. In utilizing the one-to-many mapping approach, the beam set configuration circuitry 157 may associate a set A of beams with multiple patterns of set B of beams.

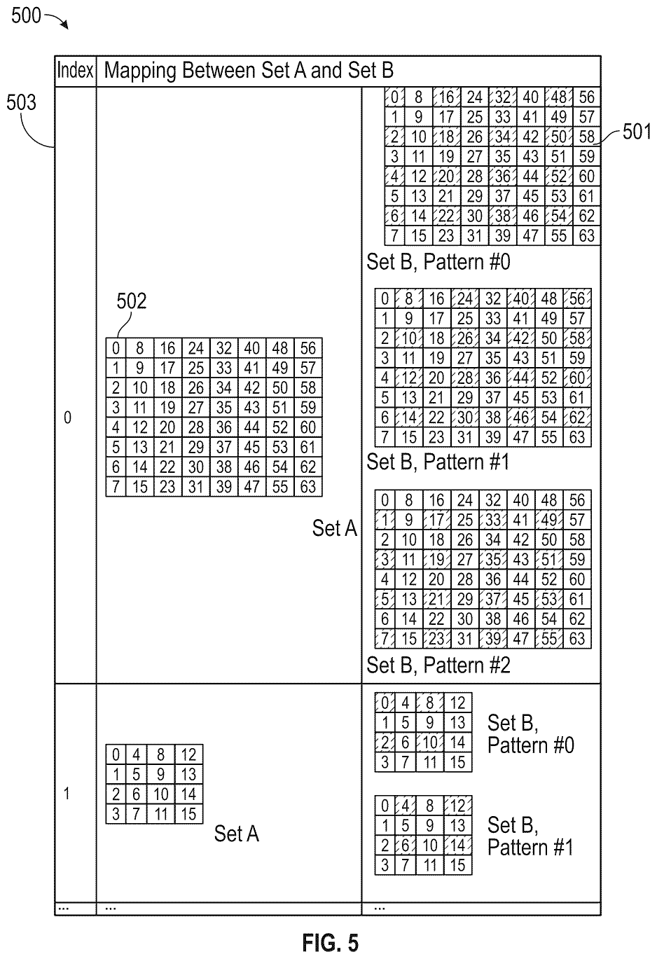

In FIG. 5 an example of a one-to-many mapping 500 between a set A of beams and multiple patterns of a set B of beams that may be implemented by the beam set configuration circuitry 157 is depicted. The one-to-many mapping 500 shows an example of multiple patterns of the set B of beams 501 that may be associated with an individual set A of beams 501 as a one-to-many map. In row 503 of the one-to-many mapping 500, index 1 shows an example of 16-DFT associated with two patterns of set B (0, 2, 8, 10) and (4, 6, 12, 14). One or more schemes may be applied to indicate the association between the set A of beams and the set B of beams in a one-to-many mapping.

During the inference phase, the gNB may indicate which pattern nay be applied such that the UE 112 may map the reference signals to the corresponding beam indices in a particular pattern of set B. To this end, the gNB may additionally indicate to the UE 112 which pattern of set B to be used during the inference phase. Via higher layer signaling (e.g., RRC parameter SetB_pattern) the gNB may indicate to the UE which pattern of set B may be applied. This parameter may part of a CSI configuration report (e.g., CSI-ReportConfig or csi-ReportSubConfigList) for regular CSI report or sub-configurations for NES. In absence of indicating the pattern of set B in the configuration, one or more rules may be used to determine which pattern of set B is to be applied (e.g., pattern with the lowest ID).

In some embodiments, the pattern of set B to be used may be indicated by the gNB communicating to the UE 112 an index of triplets which indicates set A, Set B, and the particular pattern of set B (e.g., index of set A, index of Set B, pattern of set B). In some embodiments, multiple patterns of set B may be implemented by utilizing the one-to-one mapping between Set A and Set B, as previously described. For example, in a one-to-mapping (e.g., see FIG. 4) there may be separate row for each pattern of set B. In this case, the row index may be utilized to indicate the pattern of set B to be used. The UE 112 may be able to determine that the indicated ID for a pattern of set B is aligned with the pattern of set B used during the training phase of the model.

Referring again to row 503 in the one-to-many mapping 500 showing index 1, if the gNB configures a set of four reference signals for the inference phase and indicates pattern 1 of set B to be applied (from the patterns of set B of beams 501), then the reference signals are mapped to beams (4, 6, 12, 14). For example, if CSI-RS IDs 11, 12, 18, 20 are configured, they may be mapped to the beams in Set B pattern 1 in ascending order. As an example, the CSI-RS ID 11 may be equivalent to beam 4 in pattern 1 of set B, CSI-RS ID 12 may be equivalent to beam 6 in pattern 1 of set B, CSI-RS ID 18 may be equivalent to beam 12 in pattern 1 of set B, and CSI-RS ID 20 may be equivalent to beam 14 in pattern 1 of set B. Although in the previous example, ascending order is used to map the reference signal IDs to the beams in set B, other rules may be applied (e.g., descending order, etc.). The configured reference signals utilized for inference, and the mapped beams in set B may be assumed equivalent.

In some embodiments, the set B of beams may not be a subset of the set A of beams As an example, a set B may include wide beams while set A comprises narrow beams. In this case, during the training phase, the UE 112 may train the model to interpret the differences in the configured set A and set B. Continuing with the example, the model may be trained to predict narrow beams from set A based on the measurements from wide beams from set B.

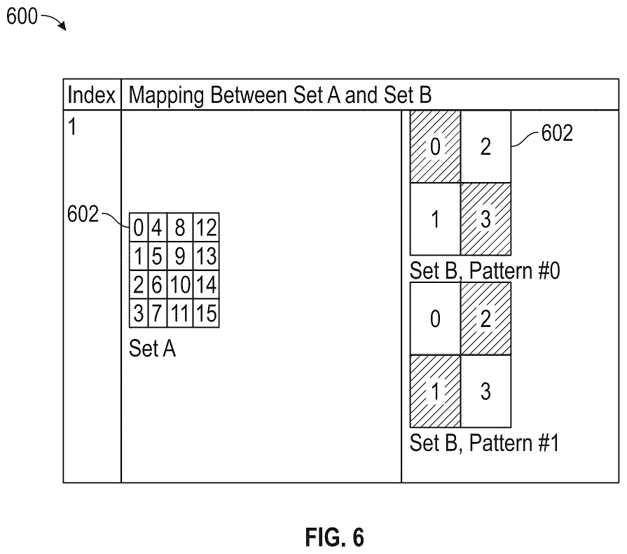

In FIG. 6, an example of a one-to-many mapping 600 between the set A of beams 601 and the multiple patterns of set B of beams 602 may be implemented by the beam set configuration circuitry 157 is depicted. In FIG. 6, the set B of beams 602 may represent different beams (e.g. wider beams) from the set A of beams 601.

The one-to-many mapping 600 shows an example of set A 601 consisting of a 16-DFT codebook while the patterns of set B 602 comprise four beams (e.g., wide beams).

Moreover, mapping the set of reference signals configured for measurement and used as input to the model to the beams (e.g., indicated in Set B of beams) may be accomplished using the approaches described above. Additionally, indicating one-to-many mappings involving a set B that is not a subset A (e.g., see FIG. 6) may be indicated to the UE 112 using approaches described above (e.g., bitmap, beam indices/IDs, etc.)

In some embodiments, reference signals that may be equivalent to the beams of a set A after the inference (e.g., UE side model), the UE 112 may report such reference signal IDs and/or other index of the refence signals (e.g. CRI, SSBRI, etc.) and the corresponding RSRP (or L1-SINR). To this end, the gNB may configure a reference signal set with the same size of set A. Those reference signals may be mapped to the beams in set A (e.g., based on the ascending order of the reference signal ID and beam ID in set A). Alternatively, for a configured reference signal, the gNB may indicate an equivalent beam number in set A (or vice versa). This indication may be carried by higher layer signaling (e.g., RRC parameter beam-in-SetA Id as part of NZP-CSI-RS-Resource).

Also, the beam indication circuitry 157 may be configured to report the set A of beams and the set B of beams after the sets have been determined and/or configured. In some cases, if set B of beams is a subset of set A of beams, beams in set B may be among the reported beams. For example, reporting based on RSRP could be based on the direct measurement on the set B or model output. In some cases, if the set B of beams is a not a subset of set A of beams, the corresponding RSRP may be based on the model outputs. The reporting of the configured set of beams may be specific to the implementation. In some embodiments, the UE 112 may include RSRPs that reasonable reflect the measured RSRPs (e.g., based on the measurement on the beams in set B) in the report.

Alternatively, there may scenarios where there may be no configured reference signal that is equivalent to the beams of Set A. For example, in a handover scenario, a new cell may not have configured reference signals that are equivalent to the beams in set A. In such scenario, the UE 112 may report the beam number from set A rather than reporting the equivalent reference signal. In other words, the beam numbers of set A, that may be known to the UE 112 during the training phase, may be treated as virtual reference signal IDs and may be included in the report.

In some configurations, the beam set configuration circuitry 157 may be configured to determine and/or configure the set A of beams and/or the set B of beams that may be utilized for implementing spatial-domain beam prediction (e.g., network side). For example, in the case of the network side model (e.g., at the gNB), the reporting may be transparent to UE 112. The gNB may utilize standard L1 measurements and/or report format (e.g., 5G NR standard), and the UE 112 may be compatible with reporting the L1 measurements as set B measurements and/or utilizing standard L1 measurement report (e.g., reports L1-RSRP for 4 maximum beam and associated beam index, CRI, SSBRI, etc.). In some embodiments, the maximum number of reported beams may be increased (e.g., up to the size of set B) in a manner that is configurable and/or based on UE capability for better performance. In some embodiments, the gNB may be configured to report additional parameters related to the set A of beams and the set B of beams (e.g., other measurement quantity, reporting more quantities, etc.) to provide greater enhancements and/or robustness (e.g., configured on top of standard CSI resource and report configurations).

Referring again to FIG. 2, the beam prediction circuitry 155 may also include beam indication circuitry 158 to implement some functions of AI-based beam management, including beam prediction. In some embodiments, beam indication circuitry 158 may be configured to perform beam indication based on a beam prediction (e.g., set A of beams), for implementing spatial-domain beam prediction (e.g., UE side). As used herein, “beam indication” may refer to a signaling mechanism used by the gNB to inform UEs about the beam or set of beams that the gNB may use for communication. In some cases, part of the configuration for the set A of beams may not be determined and/or reported with respect to configuring the set A of beams and the set B of beams, as previously described. Configuration of the set A of beams may depend on one or more aspects of the AI-based beam management operations. It may be beneficial (e.g., improved model performance) for the relationship between the set B of beams and the set A of beams to be consistent across training and inference of the model. To design a robust system, maintaining substantially the same association of set A and set B beams during training and inference stages of the model may be fundamental.

For the inference stage for the model, consistency may be maintained by previously aligning the model during the training stage. If the gNB and the UE 112 can identify the same model trained during inference stage, the set A of beams may be an index into the same model. However, after the best beam index in set A of beams (or best K beams in set A) is predicted by the model (e.g., UE side) and sent to gNB, the gNB may to assign best beam to an upcoming DL transmission to the UE 112 (e.g., Physical Downlink Shared Channel (PDSCH)). Standard beam indication (e.g., 5G NR standard) may be based on indicating the QCL and/or Transmission Configuration Indication (TCI) state with an associated reference signal. For the case of PDSCH, it may be considered for a Demodulation Reference Signal (DMRS) to have a QCL for the indicated TCI state. The reference signal associated with the TCI state may be measured by the UE 112 before a beam switch. The switching delay may depend on if the TCI state is known or unknown at the time of beam indication. Because it may be critical to have measurements for set A beams, the CSI resource and reporting for set A may still need to be configured in Radio Resource Control (RRC), in some cases. However, during inference stage of AI-based beam management, the reference signals associated with the set B of beams may be measured. In some embodiments, the beam indication circuitry 158 may be configured to execute operations to implement beam indication in cases when the reference signals in the set A of beams may not have been measured.

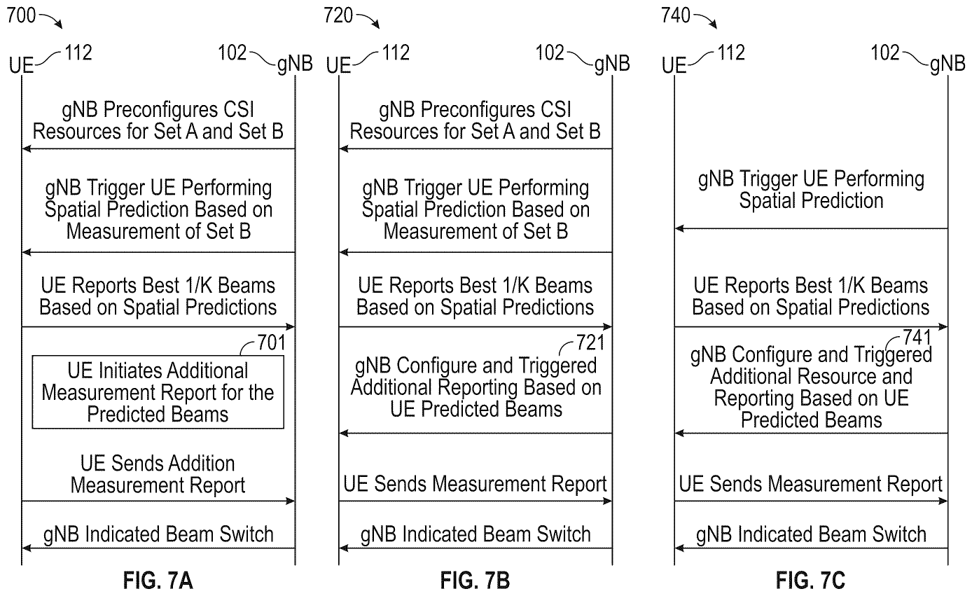

FIG. 7A depicts an example of a beam indication operation 700, where one or more aspects of the operation 700 may be executed by the beam indication circuitry 158. The beam indication operation 700 may generally be described as involving the UE 112 initiating additional reporting based on the beam prediction. In some embodiments, the gNB 102 may preconfigure the set A of beams and the set B of beams with different CSI-RS resource sets in operation 700. Since set A may include more beams than set B, set A may occupy a large resource if gNB configures it as periodic CSI-RS. To avoid increased consumption of DL resources, the reference signal for set A may have a larger period than set B, in some embodiments. As seen in FIG. 7A, after the UE 112 may report a best 1/K beam(s) to the gNB 102 in operation 700, the UE 112 may initiate (e.g., automatically, without the need of TCI activation command from gNB 102) transmission of a special CSI report 701 to the gNB 102. The report 701 may be based on the beam prediction (e.g., best 1/K beam using spatial-domain prediction) and/or the configuration of set A of beams. Additionally, in operation 700, the UE 112 may initiate transmitting an additional report to the gNB 102 based on the predicted beams (e.g., spatial-domain beam prediction). The UE 112 and gNB 102 may determine the beam switching delay for the indicated beam based on if the report initialized by the UE 112 is complete (e.g., acknowledged by gNB 102).

FIG. 7B depicts another example of a beam indication operation 720, where one or more aspects of the operation 720 may be executed by the beam indication circuitry 158. The beam indication operation 720 may generally be described as involving the gNB 102 initiating additional reporting based on the beam prediction. In operation 720, the gNB 102 may configure additional reporting after receiving the prediction report (e.g., indicating predicted beams using spatial-domain beam prediction) from the UE 112. For example, the gNB 102 may trigger the initiation of additional reports (e.g., from the UE 112) at operation 721, in response to receiving the report of the beam prediction (e.g., best 1/K beam using spatial-domain prediction) sent from the UE 112. Thereafter, the UE 112 may perform additional measurement of beams in set A based on the new configuration. Additional reporting from the UE 112 may be based on the CSI resource set for the set A of beams, with an additional indication of a subset of the beams from set A that are to be measured. The additional reporting from the UE 112 on the beams from set A may not utilize the TCI activation command from gNB 102.

FIG. 7C depicts another example of a beam indication operation 740, where one or more aspects of the operation 740 may be executed by the beam indication circuitry 158. The beam indication operation 740 may generally be described as involving the gNB 102 configuring additional resources and initiating additional reporting based on the beam prediction. In beam indication operation 740, the set A of beams may not be preconfigured, which may reduce overhead associated with DL (e.g., with a potential cost of the extra latency for additional RRC configuration and measurement time). In beam indication operation 740, the gNB 102 may configure additional resources and may trigger the initiation of additional reports (e.g., from the UE 112) at operation 741, in response to receiving the report of the beam prediction (e.g., best 1/K beam using spatial-domain prediction) sent from the UE 112. For example, the gNB 102 may configured additional reference signals for the predicted beam, which is determined and reported by the UE 112.

In some embodiments, the beam indication circuitry 158 may be configured to execute some aspects of a beam indication operation where the gNB configures the set B of beams, and then directly associates set A of beams with the configured set B of beams. In this approach, the CSI-RS resource set associated with set B may be preconfigured with additional information about the association of set A and set B. For example, in some beam codebooks, set B of beams may represents the wider beams and set A of beams may represents the larger set of finer beams (e.g., narrow beams). In this beam configuration, a beam in set B may share a group of beams in set A with an approximately same angle. TCI properties associated with reference signals in set A may be considered measured and acquired when the corresponding set B is measured. A corresponding RX spatial filter may applied for the set B beams and the associated set A beams, in some embodiments.

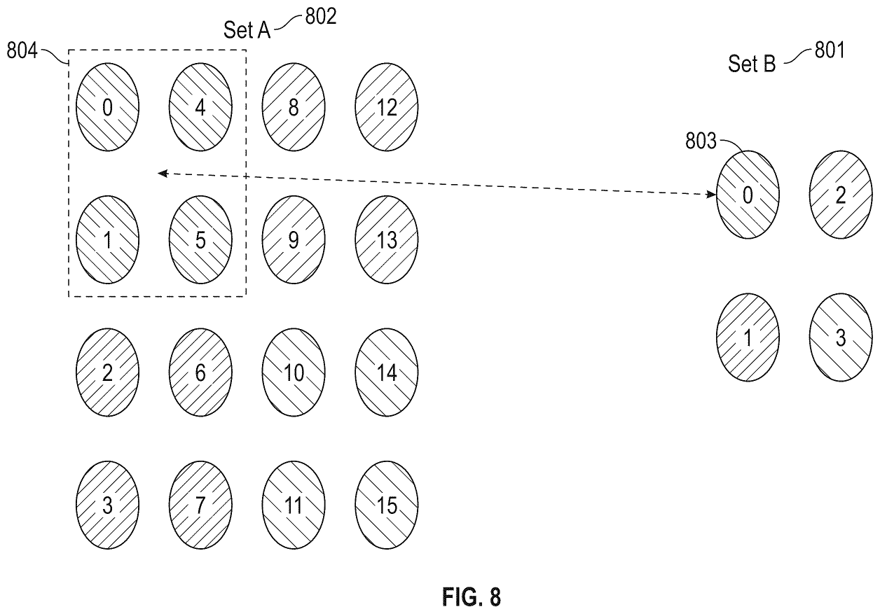

FIG. 8 depicts an example of a direct beam association 800 that may be implemented as a beam indication approach by the beam indication circuitry 158, according to some embodiments. FIG. 8 illustrates that in that in a direct beam association 800 each beam in set B 801 may be associated with one or more beams in set A 802 (indicated in FIG. 8 by same shading pattern), where the associated beams in the sets 801, 802 may have similar spatial properties. For instance, in the illustrated direct beam association 800, index “0” beam 803 in set B 801 may be associated with beams “0, 1, 4,5” shown as a subgroup 804 of beams in the set A 802. In an example, the UE 112 may predict beam 4 in set A 802 as the best beam (e.g., based on the measurement of Set B and model). The UE 112 may determine that the association of the predicted beam (beam 4 in set A 802) corresponds to index “0” beam 803 in set B 801 by configuration. Thereafter, the gNB 102 may indicate this beam for transmitting in DL (e.g., PDSCH) and the UE 112 may use the spatial filter to measure index “0” beam 803 in the set B 801. By utilizing the direct beam association operation, such as direct beam association 800, the UE 112 may avoid performing additional measurements before beam switching. In some embodiments, the CSI resource set for set A 802 may not be preconfigured in the direct beam association operations. The gNB 102 may use the TCI-state of index “0” beam 803 in set B 801 for indication but may transmit beam “4” in set A 802 (within the subgroup 804). In some cases, the gNB 102 can also configure additional operations (e.g., P3 type operation) to help the UE 112 find the optimal spatial RX filter.

In some configurations, the beam indication circuitry 158 may be configured to indicate a beam based on the beam prediction, and without transmitting additional configurations and/or additional measurements for beams in set A (e.g., see FIG. 7C), for implementing spatial-domain beam prediction (e.g., UE side). For example, in some embodiments, the predicted refence signal for a predicted beam may not be transmitted. The UE 112 may be able to predict some properties (e.g., the QCL quantity) of the beams in set A based on measuring of beams in set B in manner that achieves a form of “predicted measurement.” Thus, it may not be critical to obtain additional measurements and/or resources for the predicted beam, when the UE 112 and/or the gNB 102 has the capability to implement predicted measurements to correspond to the predicted beams. Consequently, if the TCI may utilize a predicted reference signal (as the source reference signal) it may be considered as a known TCI, even if the reference signal for the predicted beam is not transmitted in the beam indication operation. In some embodiments, the UE 112 may indicate to the gNB 102, via capability reporting, if it has the capability to perform measurement predictions.

In some embodiments, the reference signals of a predicted beam may not be transmitted. The UE 112 may be able to predict properties based on measuring reference signals in set B. Consequently, the TCI using such predicted reference signals as the source reference signals may be considered as known TCI if the predicted reference signal is not transmitted. The UE 112 may be able to indicate to the gNB 102, via capability signaling, if it supports utilizing predicted reference signals without transmitting (e.g., predicted refence signal for a predicted beam not transmitted) and indicate additional configurations for set A and/or set B (e.g., restrictions on a size of the set A and/or a size of set B) for this aspect.

For example, a source reference signal for a configured TCI state may be a virtual reference signal ID, based on observed beams (e.g., during the training phase of an AI model). In this case, the UE 112 may determine if the QCL source reference signal is a virtual reference signal or a measured RS. Subsequently, the gNB 102 may provide the UE 112 with a flag indicating if the QCL source reference signal is a virtual reference signal or a measured reference. If the flag indicates a measured reference signal, the QCL source reference signal may be a measured reference signal that has been configured and transmitted. The flag may be provided via a relatively higher layer signaling (e.g., a RRC parameter in Layer 3), which may part of the TCI configurations. The gNB 102 may deploy multiple set As, in some embodiments. Thus, the gNB 102 may indicate an additional index that refers to the set A that is to be utilized, and an association between the beams of set A and the beams of set B may be used. For example, the index to a previously used pair of set A and set B may then be reused to indicate the set A that the UE 112 may use to interpret the virtual reference signal ID.

In some embodiments, one or more properties (e.g., RX spatial properties) of the predicted beams (e.g., reference signals and/or virtual reference signal in set A) may be acquired through measurement of the reference signals in set B. Therefore, associated time conditions for a “known” TCI state may be set (or defined). As an example, a TCI state switch command may be received within a set time (e.g., 1280 ms) from a last transmission of the reference signal resource for beam reporting or measurement. The UE 112 may send at least an L1-RSRP report for a target TCI state before the TCI state switch command. A potential TCI state switch command may be received at a time (T1) from the last transmission of the reference signal resource (e.g., set B) used for prediction of target TCI states (e.g., set A). The UE 112 may transmit at least one predicted L1-RSRP report for the target TCI states (e.g., set A) before the TCI state switch command, in some embodiments.

Some embodiments may depend on the capabilities of the UE 112. For example, if the UE 112 is capable of predicting properties of beams (e.g., predicting RX spatial properties of the set A of beams from measurements of the set B of beams), may utilize different indication and/or reporting mechanisms. For example, the UE 112 may report the K best beams to the gNB 102, but thereafter the gNB 102 may indicate beams other than the K beams in set A. The UE 112 may predict and store the properties of the beams in set A (e.g., RX spatial properties), in some embodiments. In order to support these capabilities, the UE 112 may utilize additional resources (e.g., computing, storage, etc.). Thus, the capabilities of the UE 112 may be associated with the predicted properties of the set A (and the reported beams) over time. For instance, the UE 112 may utilize certain capabilities to support mechanisms that involve set B being a part of Set A, and the UE 112 may utilize different capabilities to support mechanisms that involve set B being in a different from set A.

In some embodiments, if the UE 112 is configured with the relative higher layer parameters (e.g., DLorJointTCIState and/or UL-TCIState in Layer 3) activated with TCI states for downlink transmission (by MAC CE indication of more than one codepoints), and may receive a DCI format (e.g., 1_1/1_2 format) with (or without) DL assignment (e.g., providing indicated TCI-State or TCI state pair in the active TCI list for a CC or all CCs with a common indicated TCI-State in the same CC list configured by simultaneousU-TCI-UpdateList1, simultaneousU-TCI-UpdateList2, simultaneousU-TCI-UpdateList3, simultaneousU-TCI-UpdateList4), the UE 112 may transmit a PUCCH with HARQ-ACK information corresponding to the DCI carrying the TCI-State indication. If the TCI state is known, the downlink TCI switching to the indicated DL TCI state or joint TCI state in the DCI format may be completed starting from a first slot that is at least symbols (e.g., BeamAppTime-r17) after the last symbol of the PUCCH that may include the HARQ-ACK in response to the DCI triggering TCI state activation. The first slot and the symbols (e.g., BeamAppTime-r17) may be both determined on the carrier with a smaller SCS among the carrier(s) applying the beam indication. Some aspects of AI-based beam management, as disclosed herein, may involve utilizing a unified TCI framework in order support indication of the “best” beam. Because a timeline of a “known” TCI may be different (e.g., based on Rel-17/18 unified TCI and/or Ai-based beam management), a separated time value (e.g., BeamAppTime) may be configured by the gNB 102 based on the reported value from the UE 112.

In some embodiments, implementing spatial-domain beam prediction (e.g., network side), operation during inference may be transparent to UE 112. Thus, the UE 112 may report L1 measurements based on measurements obtained from the beams of set B (configured by gNB 102). The L1 measurement report of a set size (e.g., including measurements of 4 beams) from the UE 112 may be suitable to support the gNB 102 performing AI-based inference functions based on the size of set B (e.g., set B may include more than 4 beams). In some embodiments, an L1 measurement report of an increased size may be utilized, where the report may include a relatively larger number of beams (e.g., containing measurements of more than 4 beams) based on the capabilities of the UE 112.

Referring again to FIG. 2, the beam prediction circuitry 155 may be configured to implement temporal-domain beam prediction for DL transmission, in some embodiments. The beam prediction circuitry 155 may execute temporal-domain beam prediction from the set A of beams based on measurements on the set B of beams from historic time instance(s). For example, the beam prediction circuitry 155 may execute temporal-domain beam prediction for applications where an environment (e.g., channel) may not be static during a time between measurement and prediction. Thus, it may be critical for the AI models and/or techniques used for temporal-domain beam prediction to learn the dynamic nature of channels.

In some embodiments, involving the beam prediction circuitry 155 implementing temporal-domain beam prediction for DL transmission, capabilities of the UE 112 may be reported. The UE 112 may perform UE capability reporting based on a pair of set A, set B (e.g., size of set A, size of set B) and/or other reporting mechanisms as disclosed herein. In some embodiments, a number of measurement instance(s) “K” and a number of prediction instance(s) “F” (described in greater detail below) that may be utilized for temporal-domain beam prediction may be related to aspects of AI-based models and/or capabilities (e.g., size, complexity, etc.). Time related information for temporal-domain beam prediction may also be referred to in terms of set time (e.g., T1 and T2) for measurement and prediction windows, respectively. Thus, the UE 112 may report pairs of relative time (K, F) and/or set time (T1, T2) to support of AI-based capabilities for implementing temporal-domain beam prediction.

In some embodiments, the UE 112 may report UE capabilities in a form of quadruples related to relative time (e.g., size set A, size of set B, K, F), and/or quadruples related to set time (e.g., size set A, size of Set B, T1, T2), and/or a sextuplet (e.g., size set A, size of Set B, K, F, T1, T2). In some embodiments, the UE 112 may report the UE capabilities in a form (e.g., quadruples) for each subcarrier spacing (SCS) of a downlink cell on which CSI is measured. UE capability reporting may be impacted by factors such as measurement delay and/or network structure (e.g., affects operation time during inference). Measurement windows and/or prediction windows that are substantially close may affect temporal-domain beam prediction. Thus, in some embodiments, UE capabilities may be reported at a substantially short time gap “8” between measurement windows and prediction windows such that performance of temporal-domain beam prediction may not be impacted. In some cases, it may be possible for a time gap set as 8=0 (e.g., no time gap) to be utilized by the UE 112 (e.g., measurement windows end with the latest measurement instance and prediction windows start at the first prediction instant). Also, in some embodiments, multiple instances of measurements (e.g., “K” instants of L1-RSRP measurements) for the beams of set B may be reported to the gNB 102, and UE-side additional conditions (e.g., doppler frequency) may be reported to gNB 102 as UE capabilities. For measurements at each measurement instant, the UE 112 may be able to support reporting for up to a set number of N (e.g., N>4) beams.

In some embodiments, the beam prediction circuitry 155 may be configured to execute an AI-based prediction of beams at future instant(s) based on the historic measurement results of the set B of beams (e.g., temporal-domain beam prediction). Accordingly, the beam prediction circuitry 155 may include the time instants prediction circuitry 159 to implement beam prediction at multiple time instants in the future. For example, during an inference stage, the inputs for the AI model may be the measurements (e.g. L1 RSRP) of beams in set B for K time instants during a measurement windows, and the output (e.g., beam predictions) of the AI model may be associated metrics (e.g., predicted RSRPs, probability of beams, etc.) for F time instants during the prediction windows. In other words, “K” may refer to measurement time instants, and “F” may refer to prediction time instants. Due to the temporal considerations associated with temporal-domain beam predictions, the time instants prediction circuitry 159 may be configured to define time instants of predictions (e.g., future instants) during its inference stage. The time instants prediction circuitry 159 may be configured to implement various operations with different reference timing to achieve temporal-domain beam prediction, as disclosed here. Time instants may be determined based on reference signals (e.g., CSI-RS) and/or the time instants of reporting (e.g., timing of CSI reports to transmit beam predictions to gNB 102), according to some embodiments.

In some embodiments, the time instants prediction circuitry 158 may be configured to determine time instants (e.g., future instants) based on the using the time instants of reference signals as reference timing. The measurements of the beams in set B (e.g., DL beams) may be utilized as input for AI models, where a time step for the AI model may be based on the measurement timing. Therefore, the measurement window (e.g., measurement instants K) and/or the predication window (e.g., prediction instants F) may be defined based on the reference signals. In a measurement window, multiple measurement instants K may be configured, and each measurement instant K may include resources for an entire set B of beams. For example, a DL reference signal may be semipersistent (or periodic CSI-RS), and a set of time instants [t_{-(K-1)}, . . . , t₋₁, t₀] may be the measurement instants K, where to is the latest measurement time instant determined by a CSI reference resource associated with the CSI report.

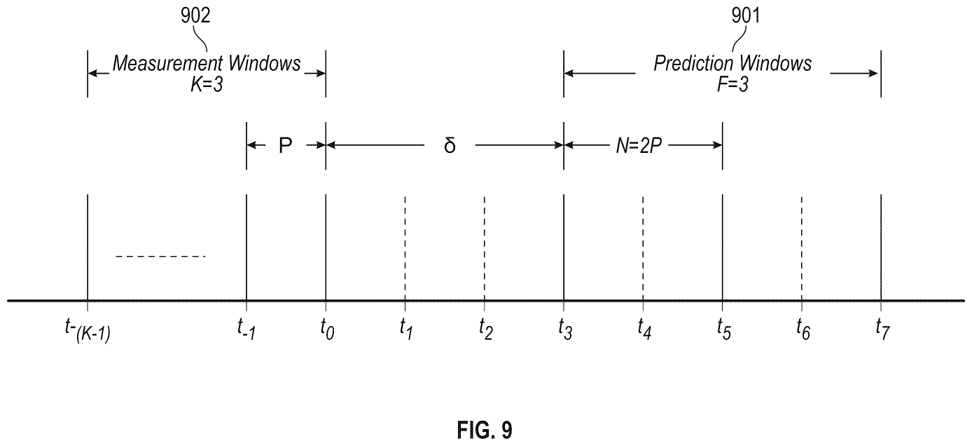

FIG. 9 is a diagram depicting a timing operation 900 based on time instants of reference signals that may be implemented by the time instants prediction circuitry 158 (e.g., see FIG. 1). As seen in FIG. 9, a prediction windows 901 may contain F prediction time instants starting at a time based on a time gap δ from the measurement windows 902 (e.g., prediction windows 901 starting at t₀+δ). In the example of FIG. 9, “N” may refer to an interval between the time instants in prediction windows 901. The time interval N may be represented mathematically as N=2P in this example, where P may refer to a distance between two consecutive measurement time instants K for measuring the reference signals in measurement windows 902. The timing parameters that may be utilized in the operation 900 (e.g., K, F, δ and N) may be configured by higher layer signaling according to the reporting UE capabilities, in some embodiments. By observing the reference timing within the measurement windows 902, the timing operation 900 may be utilized to determine the timing for predictions within the prediction windows 901. For instance, a start time and/or intervals that may be utilized for determining the future timing instants related to beam predictions can be derived from observing the time instants of measured reference signals within the measurement windows 902. Thus, by executing timing operation 900 the time instants prediction circuitry 159 may determine prediction windows 901 (e.g., F time instants), as defined by time instants of reference signals (e.g., K time instants).

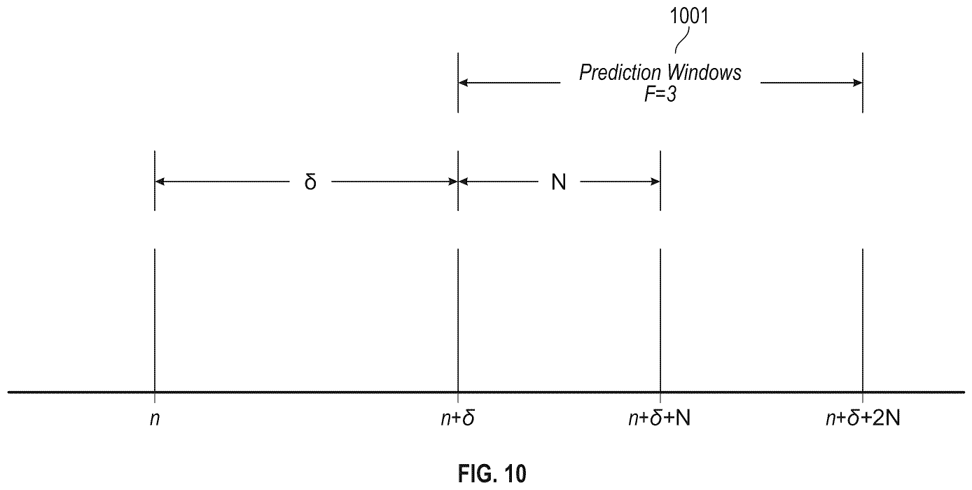

In some embodiments, the time instants prediction circuitry 158 may be configured to determine time instants for predictions (e.g., future instants) based on time instants of the reporting. FIG. 10 is a diagram depicting a timing operation 1000 based on the time instants of reporting that may be implemented by the time instants prediction circuitry 158 (e.g., see FIG. 1). In timing operation 1000, the report timing instants may be utilized as the reference timing to ultimately define F time instants for the beam predictions. In some cases, when a beam report is sent to the network (e.g., gNB), the predictions that are made after the time that report is received (e.g., future predictions) may be useful for the AI-based beam management functions. Therefore, it may be plausible to define the prediction windows 1001 based on the time a transmission (e.g., PUSCH, PUCCH, etc.) contains beam reporting. In the timing operation 1000, “n” may refer to a time instant where an UL transmission of a report (e.g., CSI report) is communicated. The prediction windows 1001 may contain F time instants starting at a time based on a time gap δ from the report timing (e.g., prediction window 1001 starting at n+δ) and may have an interval N. The timing parameters that may be utilized in the operation 1000 (e.g., n, F, δ and N) may be configured by higher layer signaling according to the reporting UE capabilities, in some embodiments. Thus, by executing timing operation 900 the time instants prediction circuitry 159 the future time instants for beam predictions may be defined by report timing.

The UE 111 may be configured to implement mechanisms that reduce inefficiencies, such as overhead, that may be related to reporting for temporal-domain beam prediction. The mechanisms for reducing reporting overhead may be configurable by the gNB 102 and based on the capabilities that are supported by the UE 112.

In some embodiments, the UE 112 may be configured to reduce the overhead for representing a differential part of RSRP. For example, the UE 112 may reduce of number of bits utilized to represent each differential RSRP comparing to the best beam (with strongest RSRP). This approach may be substantially similar changing quantization methods of the reported RSRP. The UE 112 may also reduce a number of beams included for a single time instant in a report.

In some embodiments, the UE 112 may be configured to reduce the overhead for representing a value of a measurement (e.g., RSRP) for the strongest beam. For example, the UE 112 may reduce the overhead for representing the RSRP for the strongest beam for each time instant. This approach may be substantially similar changing quantization methods of the reported RSRP. The UE 112 may also utilize differential encoding over multiple time instants to reduce the overhead for representing a value of a measurement. For example, the UE 112 may report the strongest beam for multiple time instants (whole F time instant or divided into N subset of F), and for each time instant the number of beams in differential RSRP are reported. Reporting a relatively smaller number of beams in differential RSRP may have reduced overhead compared to reporting each RSRP value for a larger number of beams.

In some embodiments, the “known” TCI states may be set (or defined) for set A to support implementing temporal-domain beam prediction. For example, a predicted TCI state utilized in beam indication aspects, as disclosed herein, may be considered “known” if: it is within the prediction windows; it is within the prediction windows and/or the extension of prediction windows (e.g., prediction windows+T2); it is within T3 after the latest transmission of measurement reference signal (e.g., the latest transmission reference signal in the measurement windows).

Beam indication aspects for temporal-domain beam prediction may include dynamics of beams information in the future in terms of predicted beams in multiple time instants. Because the gNB 102 may utilized this temporal based information, the gNB 102 may be able to indicate multiple beams (TCI-state) in sequence into the future. In some embodiments, for a single transmission reception point (TRP), MAC-CE may be used to activate multiple TCI-states and DCI may be used to indicated single TCI-states among the activated TCI-states, in accordance with some wireless communication technology standards (e.g., 5G NR). Thus, the UE 112 may be configured to implement mechanisms to indicate multiple future TCI-states to support temporal-domain beam prediction. The mechanisms for indicating multiple future TCI-states for temporal-domain beam prediction may be configured based on the capabilities supported by the UE 112.

In some embodiments, the UE 112 may be configured to utilize a modified DCI format to indicate multiple future TCI states in sequence. For example, each instant may have a corresponding field in DCI format. Indicated TCI states with an activated TCI state may be activated by MAC CE.

In some embodiments, a table of TCI-state sequences may be configured by the RRC and utilized to indicate multiple future TCI-states for temporal-domain beam prediction. For example, each row of the table may represent a sequence of future TCI-states and DCI may indicate the index of a row in the table.

Time regions may be set (or defined) for future indicated TCI-states. The time offset from the first indicated TCI state may be related to the DCI (or MAC-CE) and may be substantially same (or a separated configured) as a beam application time, or dynamically indicated by DCI (or MAC CE). The duration of each indicated TCI-states may be determined (e.g., fixed, static, predetermined, etc.), may be based on RRC configurations, and/or may be indicated in DCI (or MAC-CE). The switching time between two consecutive indicated TCI-states: This can be fixed or configured by RRC or indicated in DCI (or MAC-CE).

Data collection aspects of AI-based beam management may be implemented to support temporal-domain beam prediction. In some embodiments, the UE 112 may be configured to support CSI-Report configuration. The UE 112 configured with a CSI report may measure the DL channel and may computer the CSI and reports it as a UCI to the gNB 102. If the UE 112 collects data, it may not report the CSI to the gNB 102. This may impact the UE 112, as the UCI transmission may utilize rUL processing including channel coding, waveform generation and other steps of a UL channel transmission. Therefore, it may be indicated to the UE 112 if it is to perform data collection (e.g., rather than report the CSI). Such an indication for data collection may be implemented dynamically via RRC and/or dynamically via L1 signalling (e.g., in DCI). The CSI-report configuration may include an information element (IE) which may indicate if the report is for data collection. In some embodiments, the UE 112 may be configured to support occupation time for data collection aspects to support temporal-domain beam prediction. A data collection type of a CSI may occupy resources (e.g., CPU) for a certain duration of time (e.g., occupation window). For a CSI report configuration for which the UE 112 may report the CSI to the gNB 102, the occupation window may end at the end of the ending symbol of the UL channel conveying the CSI report. If there is no CSI report to the gNB 102, the occupation window may end at set time after it starts. A “semi-persistent CSI report” (excluding an initial semi-persistent CSI report on PUSCH after the PDCCH triggering the report) may refer to a report that occupies CPU(s) from the first symbol of the earliest one of each transmission occasion of periodic or semi-persistent CSI-RS/SSB resource for channel measurement for L1-RSRP computation, until Z′₃ symbols after the last symbol of the latest one of the CSI-RS/SSB resource for channel measurement for L1-RSRP computation in each transmission occasion. An “aperiodic CSI report” may refer to a report that occupies CPU(s) from the first symbol after the PDCCH triggering the CSI report until the last symbol between Z₃ symbols after the first symbol after the PDCCH triggering the CSI report and Z′₃ symbols after the last symbol of the latest one of each CSI-RS/SSB resource for channel measurement for L1-RSRP computation.

For example, an occupation window may start from the first symbol the RS in each transmission occasion and may end after symbols (e.g., Z′₃ symbols) after the last symbol of the latest reference signal in the transmission occasion. The transmission occasion may be set (e.g., defined) from the first symbol of the earliest reference signal in the CSI-RS set to the ending symbol of the latest CSI-RS in the set within a period for SP/P CSI report. It may also be set (e.g., defined) from the first symbol of the earliest CSI-RS to the ending symbol of the latest CSI-RS in the triggered AP-CSI RS set by the DCI. Thus, the data collection may be based on Z₃ and Z′₃. New values of Z₃ and Z′₃ may be defined (values may be based on offsets) for AI-based beam management, as disclosed herein, and may not involve refining DL RX beam.

Thus, embodiments of the present disclosure may provide systems and methods for AI-based beam management, including beam prediction, in a manner that may maintain the robustness and efficiency of AI capabilities and mitigate the restrictions that some standard functionality wireless communication technologies may impose on AI. Embodiments of the present disclosure may support several functions to implement beam management that is enhanced and/or automatically optimized by AI. Thus, beam prediction in a spatial-domain and a temporal domain; enhanced UE reporting capabilities; configuration of a set A of beams and a set B of beams; beam indication; and time instants prediction, as disclosed in detail herein. Thus, the disclosed embodiments may improve the efficiency, range, and overall performance of wireless communication network through achieving an optimized integration of AI.

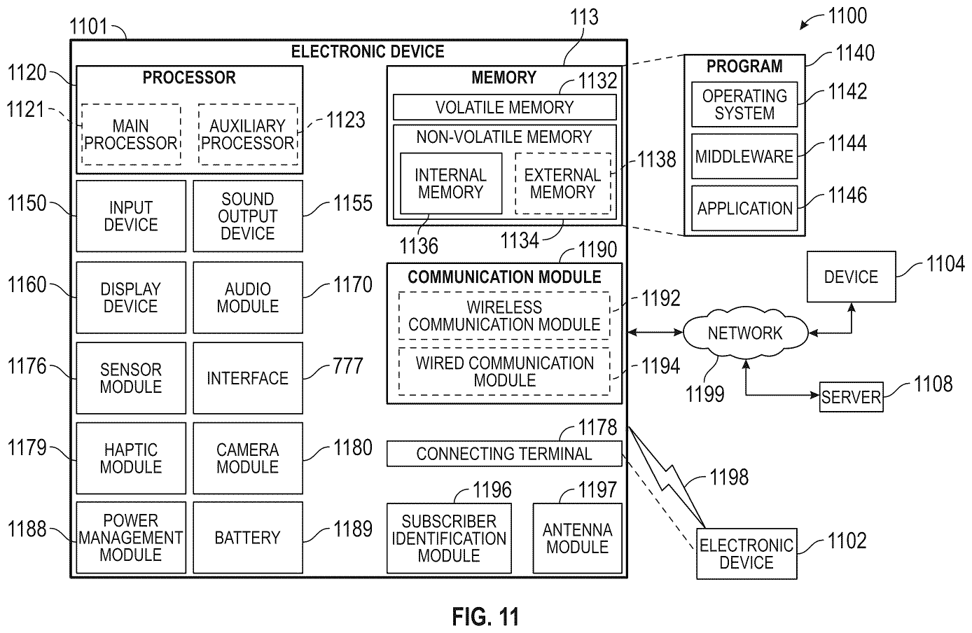

FIG. 11 is a block diagram of an electronic device in a network environment 1100, according to an embodiment.

Referring to FIG. 11, an electronic device 1101 in a network environment 1100 may communicate with an electronic device 1102 via a first network 1198 (e.g., a short-range wireless communication network), or an electronic device 1104 or a server 1108 via a second network 1199 (e.g., a long-range wireless communication network). The electronic device 1101 may communicate with the electronic device 1104 via the server 1108. The electronic device 1101 may include a processor 1120, a memory 1130, an input device 1150, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) card 1196, or an antenna module 1197. In one embodiment, at least one (e.g., the display device 1160 or the camera module 1180) of the components may be omitted from the electronic device 1101, or one or more other components may be added to the electronic device 1101. Some of the components may be implemented as a single integrated circuit (IC). For example, the sensor module 1176 (e.g., a fingerprint sensor, an iris sensor, or an illuminance sensor) may be embedded in the display device 1160 (e.g., a display).

The processor 1120 may execute software (e.g., a program 1140) to control at least one other component (e.g., a hardware or a software component) of the electronic device 1101 coupled with the processor 1120 and may perform various data processing or computations.

As at least part of the data processing or computations, the processor 1120 may load a command or data received from another component (e.g., the sensor module 1176 or the communication module 1190) in volatile memory 1132, process the command or the data stored in the volatile memory 1132, and store resulting data in non-volatile memory 1134. The processor 1120 may include a main processor 1121 (e.g., a central processing unit (CPU) or an application processor (AP)), and an auxiliary processor 1123 (e.g., a graphics processing unit (GPU), an image signal processor (ISP), a sensor hub processor, or a communication processor (CP)) that is operable independently from, or in conjunction with, the main processor 1121. Additionally or alternatively, the auxiliary processor 1123 may be adapted to consume less power than the main processor 1121, or execute a particular function. The auxiliary processor 1123 may be implemented as being separate from, or a part of, the main processor 1121.

The auxiliary processor 1123 may control at least some of the functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). The auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134. Non-volatile memory 1134 may include internal memory 1136 and/or external memory 1138.

The program 1140 may be stored in the memory 1130 as software, and may include, for example, an operating system (OS) 1142, middleware 1144, or an application 1146.

The input device 1150 may receive a command or data to be used by another component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1160 may visually provide information to the outside (e.g., a user) of the electronic device 1101. The display device 1160 may include, for example, a display, a hologram device, or a projector and control circuitry to control a corresponding one of the display, hologram device, and projector. The display device 1160 may include touch circuitry adapted to detect a touch, or sensor circuitry (e.g., a pressure sensor) adapted to measure the intensity of force incurred by the touch.

The audio module 1170 may convert a sound into an electrical signal and vice versa. The audio module 1170 may obtain the sound via the input device 1150 or output the sound via the sound output device 1155 or a headphone of an external electronic device 1102 directly (e.g., wired) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device 1102 directly (e.g., wired) or wirelessly. The interface 1177 may include, for example, a high-definition multimedia interface (HDMI), a universal serial bus (USB) interface, a secure digital (SD) card interface, or an audio interface.

A connecting terminal 1178 may include a connector via which the electronic device 1101 may be physically connected with the external electronic device 1102. The connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via tactile sensation or kinesthetic sensation. The haptic module 1179 may include, for example, a motor, a piezoelectric element, or an electrical stimulator.

The camera module 1180 may capture a still image or moving images. The camera module 1180 may include one or more lenses, image sensors, image signal processors, or flashes. The power management module 1188 may manage power supplied to the electronic device 1101. The power management module 1188 may be implemented as at least part of, for example, a power management integrated circuit (PMIC).

The battery 1189 may supply power to at least one component of the electronic device 1101. The battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the AP) and supports a direct (e.g., wired) communication or a wireless communication. The communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as BLUETOOTH™, wireless-fidelity (Wi-Fi) direct, or a standard of the Infrared Data Association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. The antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

Commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. All or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

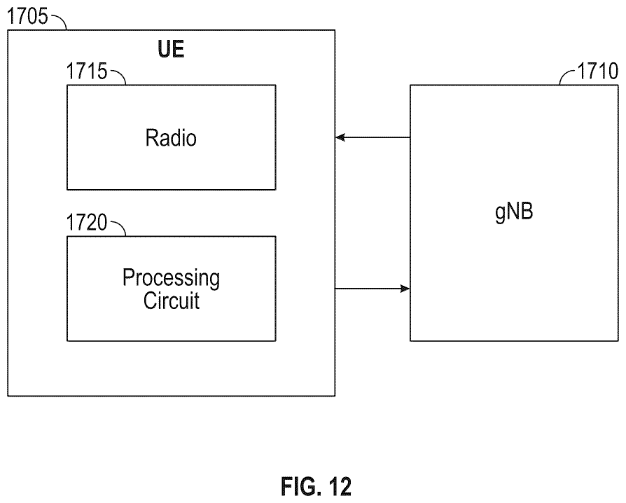

FIG. 12 shows a system including a UE 1205 and a gNB 1210, in communication with each other. The UE may include a radio 1215 and a processing circuit (or a means for processing) 1220, which may perform various methods disclosed herein, e.g., the functions and methods illustrated in FIG. 1. For example, the processing circuit 1220 may receive, via the radio 1215, transmissions from the network node (gNB) 1210, and the processing circuit 1220 may transmit, via the radio 1215, signals to the gNB 1210.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein.

Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above but is instead defined by the following claims.

What is claimed is:

1. A method comprising:
obtaining, by a processor, measurements for a first set of beams, wherein the first set of beams are received to establish a communication link;
generating, by an Artificial Intelligence (AI) model, a beam prediction on a second set of beams based on the measurements of the first set of beams;
selecting, by a processor, a beam from the second set of beams based on the beam prediction; and
establishing, by a processor, the communication link using the beam selected from the second set of beams.

2. The method of claim 1, wherein the beam prediction comprises a spatial prediction and the AI model is at a user equipment (UE).

3. The method of claim 2, further comprising reporting capabilities of the UE related to the AI model based on a size of the first set of beams and a size of the second set of beams.

3. The method of claim 2, further comprising configuring the first set of beams and the second set of beams by defining an association between the first set of beams and the second set of beams.

4. The method of claim 3, wherein the defining the association comprises indicating a one-to-one mapping between the second set of beams and the first set of beams.

5. The method of claim 3, wherein the defining the association comprises indicating a one-to-many mapping between the second set of beams and the first set of beams.

6. The method of claim 1, further comprising indicating beams in the second set of beams.

7. The method of claim 6, wherein the indicating the beams comprises the UE initiating additional measurement reporting based on the second set of beams.

8. The method of claim 6, wherein the indicating the beams comprises a base station initiating additional measurement reporting based on the second set of beams.

9. The method of claim 6, wherein the indicating the beams comprises a base station configuring an additional resource and initiating additional measurement reporting based on the second set of beams.

10. The method of claim 6, wherein the indicating the beams comprises indicating a direct association between the first set of beams and the second set of beams.

11. The method of claim 1, wherein the beam prediction comprises a temporal beam prediction.

12. The method of claim 11, further comprising predicting future instants related to the beam prediction based on timing of reference signals associated with the first set of beams.

13. The method of claim 11, further comprising predicting future instants related to the beam prediction based on timing of reporting.

14. The method of claim 1, wherein the beam prediction comprises a top beam probability for each beam in the second set of beams.

15. The method of claim 14, further comprising determining a top beam from the second set of beams based on the top beam probability.

16. The method of claim 15, wherein the communication link comprises a downlink transmission to a user equipment (UE).

17. A device comprising:
one or more processors that are configured to perform:
obtaining measurements for each beam in a first set of beams, wherein the first set of beams are received to establish a communication link;
generating a beam prediction for each beam in a second set of beams based on the measurements of the first set of beams and an Artificial Intelligence (AI) model;
selecting a beam from the second set of beams based on the beam prediction; and
establishing the communication link using the beam selected from the second set of beams.

18. The device of claim 17, wherein the device comprises a user equipment (UE).

19. The device of claim 18, wherein the communication link comprises a downlink from a Next Generation NodeB (gNB).

20. A system comprising:
a processing circuit; and
a memory device storing instructions, which, based on being executed by the processing circuit, cause the processing circuit to perform:
obtaining measurements for a first set of beams, wherein the first set of beams are received to establish a communication link;
generating a beam prediction for each beam in a second set of beams based on the measurements of the first set of beams and an artificial intelligence (AI) model;
selecting a beam from the second set of beams based on the beam prediction; and
establishing the communication link using the beam selected from the second set of beams.
